(19) United States
(12) Patent Application Publication
(10) Pub. No.: US 2009/0201792 A1
(43) Pub. Date: Aug. 13, 2009

(54) Optical Disc Recording Device, Recording Method, Optical Disc, and Optical Disc Playback Device

(76) Inventors: Toshihiro FUJIKI, Tokyo (JP); Seiji Kobayashi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/365,929

(22) Filed: Feb. 5, 2009

(30) Foreign Application Priority Data
Feb. 7, 2008 (JP) P2008-028060

(51) Int. Cl. G11B 7/24; G11B 7/00

(52) U.S. Cl. 369/275.3; 369/112.23; G9B/7

(57) ABSTRACT

An optical disc recording device includes a recording unit configured to apply optical beams, on an optical disc on which a main-data sequence is recorded in advance by forming recording marks and spaces having lengths corresponding to the main-data sequence on a track center line on an information recording surface of the optical disc, to a desired application position that is displaced in a disc inner-outer circumferential direction by a specific distance from the track center line in a recording mark having a specific length or more or a space having the specific length or more, or in the recording mark and the space each having the specific length or more, and thus locally change a reflectance of the information recording surface, so that a sub-data sequence is recorded on the optical disc.

### CROSS REFERENCES TO RELATED APPLICATIONS

The present invention contains subject matter related to Japanese Patent Application JP 2008-028060 filed in the Japanese Patent Office on Feb. 7, 2008, the entire contents of which are incorporated herein by reference.

### BACKGROUND OF THE INVENTION

1. Field of the Invention

The present invention relates to an optical disc recording device, a recording method, an optical disc, and an optical disc playback device, and is applicable to optical discs supported by various systems such as compact discs (CDs), digital versatile discs (DVDs), and Blu-ray discs (registered trademark) (BDs).

2. Description of the Related Art

For example, in the case of CDs, a data sequence to be recorded is processed, and the processed data sequence is subjected to eight-to-fourteen modulation (EFM), so that pits each having a length in a range from 3T to 11T, where T represents a predetermined reference length, are formed. Accordingly, audio data and the like are recorded.

Read-only memory (ROM) media, such as CD-ROMs, DVD-ROMs, or BD-ROMs, are produced by forming pit sequences representing data by using a mold called a stamper.

It is assumed that ROM media having audio data, video data, and the like recorded thereon are sold. If a ROM medium having data simply recorded thereon is sold, an optical disc on which illegally copied data is recorded can be easily produced.

Under such circumstances, an optical disc is suggested, for example, in Japanese Unexamined Patent Application Publication No. 2006-127756. In this optical disc, at the time when a pit sequence representing data is recorded on a ROM medium, the pit sequence is formed so as to be displaced in a radial direction of the optical disc, and key data for decoding the ROM medium is embedded in the ROM medium.

### SUMMARY OF THE INVENTION

However, a ROM medium having such a configuration can be copied by transferring a pit sequence and creating a stamper while detaching a protection film and an aluminum reflective film from the ROM medium to cause the pit sequence to be exposed. Thus, there is a problem in which an optical disc on which illegally copied data is recorded can be produced.

It is desirable to suggest an optical disc recording device, a recording method, an optical disc, and an optical disc playback device that are capable of making it difficult to produce an optical disc having illegally copied data recorded thereon.

According to an embodiment of the present invention, there is provided an optical disc recording device including a recording unit configured to apply optical beams, on an optical disc on which a main-data sequence is recorded in advance by forming recording marks and spaces having lengths corresponding to the main-data sequence on a track center line on an information recording surface of the optical disc, to a desired application position that is displaced in a disc inner-outer circumferential direction by a specific distance from the track center line in a recording mark having a specific length or more or a space having the specific length or more, or in the recording mark and the space each having the specific length or more, and thus locally change a reflectance of the information recording surface, so that a sub-data sequence is recorded on the optical disc.

Thus, a, sub-data sequence can be recorded on an optical disc in such a manner that it is difficult to copy the sub-data sequence.

According to another embodiment of the present invention, there is provided a recording method including the steps of applying optical beams, on an optical disc on which a main-data sequence is recorded in advance by forming recording marks and spaces having lengths corresponding to the main-data sequence on a track center line on an information recording surface of the optical disc, to a desired application position that is displaced in a disc inner-outer circumferential direction by a specific distance from the track center line in a recording mark having a specific length or more or a space having the specific length or more, or in the recording mark and the space each having the specific length or more, and thus locally changing a reflectance of the information recording surface, so that a sub-data sequence is recorded on the optical disc.

Thus, a sub-data sequence can be recorded on an optical disc in such a manner that it is difficult to copy the sub-data sequence.

According to another embodiment of the present invention, there is provided an optical disc, on which a main-data sequence is recorded by forming recording marks and spaces having lengths corresponding to the main-data sequence on a track center line on an information recording surface of the optical disc and a sub-data sequence is recorded by locally changing a reflectance of the information recording surface in a desired application position that is displaced in a disc inner-outer circumferential direction by a specific distance from the track center line in a recording mark having a specific length or more or a space having the specific length or more, or in the recording mark and the space each having the specific length or more.

Thus, a sub-data sequence can be recorded on an optical disc in such a manner that it is difficult to copy the sub-data sequence.

According to another embodiment of the present invention, there is provided an optical disc playback device including a light source configured to emit optical beams; an objective lens configured to collect the optical beams and apply the collected optical beams to an optical disc on which a main-data sequence is recorded by forming recording marks and spaces having lengths corresponding to the main-data sequence on a track center line on an information recording surface of the optical disc and a sub-data sequence is recorded by locally changing a reflectance of the information recording surface in a desired application position that is displaced in a disc inner-outer circumferential direction by a specific distance from the track center line in a recording mark having a specific length or more or a space having the specific length or more, or in the recording mark and the space each having the specific length or more; a light-receiving unit configured to receive, in two detection areas equally divided in the disc inner-outer circumferential direction, reflected optical beams that are the optical beams reflected by the optical disc; a main reproducing unit configured to reproduce the main-data sequence on the basis of the total amount of the reflected optical beams; a sub-reproducing unit configured to reproduce the sub-data sequence on the basis of a change in the difference between the amounts of the reflected optical beams in the two detection areas; and a reproduction stopping unit configured to stop reproduction of the main-data sequence in a case where the sub-data sequence is not correctly reproduced.

Thus, an optical disc on which a sub-data sequence which is difficult to copy is not recorded is determined to be an unauthorized optical disc, and main data recorded on the unauthorized optical disc is prevented from being reproduced.

According to an embodiment of the present invention, a sub-data sequence can be recorded on an optical disc in such a manner that it is difficult to copy the sub-data sequence. Consequently, an optical disc recording device, a recording method, and an optical disc that are capable of making it difficult to produce an optical disc on which illegally copied data is recorded can be realized.

In addition, according to an embodiment of the present invention, an optical disc playback device that is capable of determining an optical disc on which a sub-data sequence which is difficult to copy is not recorded to be an unauthorized optical disc, preventing main data recorded on the unauthorized optical disc from being reproduced, and thus making it difficult to produce an optical disc on which illegally copied data is recorded can be realized.

### BRIEF DESCRIPTION OF THE DRAWINGS

FIGS. 1A and 1B are schematic diagrams showing the configuration of a copy protection system;

FIG. 2 is a schematic diagram showing the configuration of an optical disc;

FIG. 3 is a schematic diagram for explaining formation of a code mark;

FIG. 4 is a schematic diagram showing the configuration of frames;

FIG. 5 is a schematic diagram showing the entire configuration of a finishing device;

FIGS. 6A to 6C are schematic diagrams for explaining the relationship between a spot and a reflected spot;

FIGS. 7A to 7C are schematic diagrams for explaining movement of an objective lens;

FIG. 8 is a schematic diagram for explaining movement of a spot;

FIG. 9 is a schematic diagram showing the configuration of a recording controller;

FIG. 10 is a schematic diagram showing the relationship between each signal and a code mark;

FIG. 11 is a schematic diagram showing the configuration of a modulation circuit used in a first embodiment;

FIG. 12 is a schematic diagram showing an output table;

FIG. 13 is a schematic diagram showing the configuration of an optical disc playback device according to the first embodiment;

FIG. 14 is a schematic diagram showing the configuration of a disc identification code reproducing circuit;

FIG. 15 is a schematic diagram showing the configuration of a recording controller used in a second embodiment;

FIG. 16 is a schematic diagram showing the configuration of a 9T-or-more-long pattern detection circuit;

FIG. 17 is a schematic diagram showing the configuration of a 9T-or-more-long pattern prediction circuit;

FIGS. 18A and 18B are schematic diagrams showing an optical pickup unit used in a third embodiment;

FIG. 19 is a schematic diagram showing the configuration of a recording controller used in the third embodiment; and

FIG. 20 is a schematic diagram showing the configuration of a modulation circuit used in the third embodiment.

### DESCRIPTION OF THE PREFERRED EMBODIMENTS

Embodiments of the present invention will be described with reference to the drawings.

### First Embodiment

### (1-1) Configuration of Copy Protection System

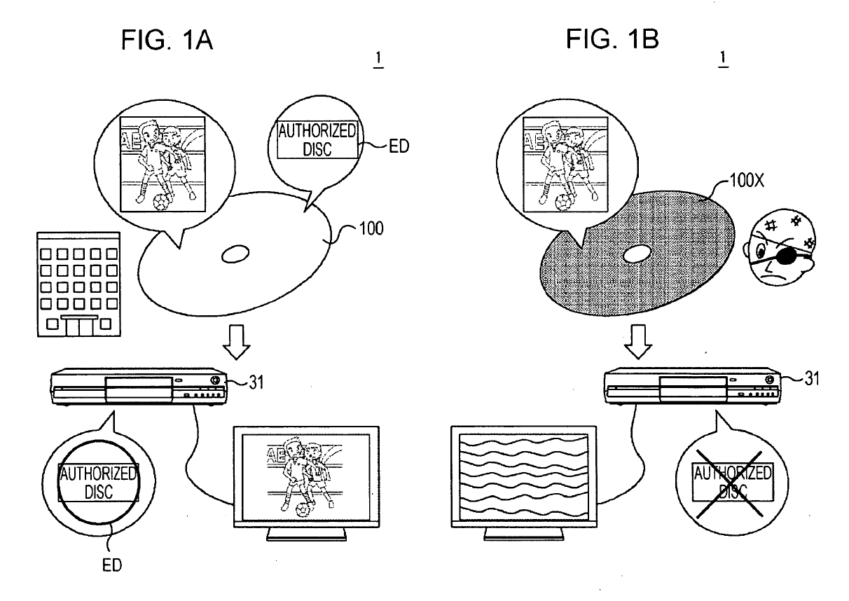

As shown in FIG. 1A, in a copy protection system 1, main data such as video data or music data is recorded, for example, as a pit sequence, on an optical disc 100, and disc identification code ED indicating, as sub-data, that the optical disc 100 is an authorized optical disc 100 is modulated in a specific method and is recorded, as modulated identification code EDr, on the optical disc 100. Apparently, the state where the modulated identification code EDr is recorded is not visible. However, the modulated identification code EDr is recorded as a code mark MK, which can be read by an optical disc playback device 31, separately from a pit sequence.

In a case where the disc identification code ED can be reproduced from the modulated identification code EDr read from the optical disc 100, the optical disc playback device 31 that plays back the optical disc 100 determines that the optical disc 100 has been produced in an authorized manner. Thus, the optical disc playback device 31 reproduces main data recorded on the optical disc 100.

In a case where the modulated identification code EDr is not recorded on an optical disc and the disc identification code ED is thus not reproduced, as shown in FIG. 1B, the optical disc playback device 31 determines that the optical disc is an illegally copied, unauthorized optical disc 100X, which is, for example, a so-called pirated optical disc. Thus, the optical disc playback device 31 does not reproduce main data recorded on the unauthorized optical disc 100X.

Thus, even if a third party produces an unauthorized optical disc 100X where only pit sequences are copied by using a stamper formed on the basis of the optical disc 100, the unauthorized optical disc 100X is not played back. In order to play back the unauthorized optical disc 100X, it is further necessary to record the modulated identification code EDr on the unauthorized optical disc 100X.

In addition, since a code mark is formed in the optical disc 100 in such a manner that the code mark is not visible, a third party is not able to steal the modulated identification code EDr from the optical disc 100.

Furthermore, in the optical disc 100, the disc identification code ED is modulated in a specific method, and the modulated disc identification code ED is recorded as the modulated identification code EDr. Thus, in a case where a third party desires to record the modulated identification code EDr in an unauthorized optical disc 100X, it is necessary to modulate the disc identification code ED in the same format as that used for the optical disc 100. Consequently, the optical disc 100 makes it further difficult for a third party to record the modulated identification code EDr.

That is, in the copy protection system 1, it is extremely difficult to produce an unauthorized optical disc 100X that can be played back. Thus, a third party is substantially prevented from selling the unauthorized optical disc 100X.

As described above, in the copy protection system 1, the modulated identification code EDr, which is obtained by modulation in a specific method as the code mark MK which is difficult to view, is recorded on the optical disc 100, and the optical disc playback device 31 is permitted to play back the optical disc 100 only when the modulated identification code EDr is recorded on the optical disc 100. Consequently, the copy protection system 1 is capable of substantially preventing mass production of unauthorized optical discs 100X by using a stamper.

### (1-2) Production of Optical Disc

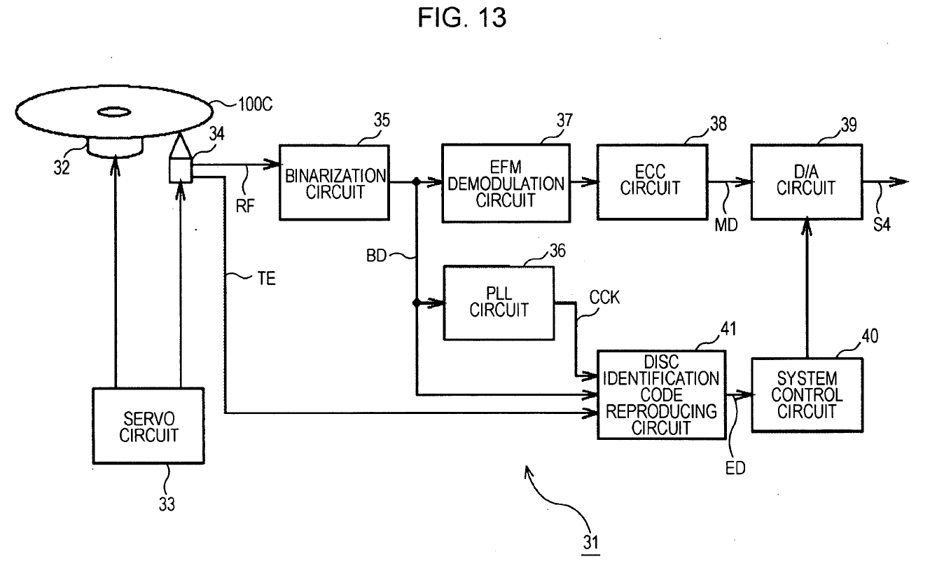

In this embodiment, a CD-type optical disc 100C (see FIG. 13) will be described by way of example.

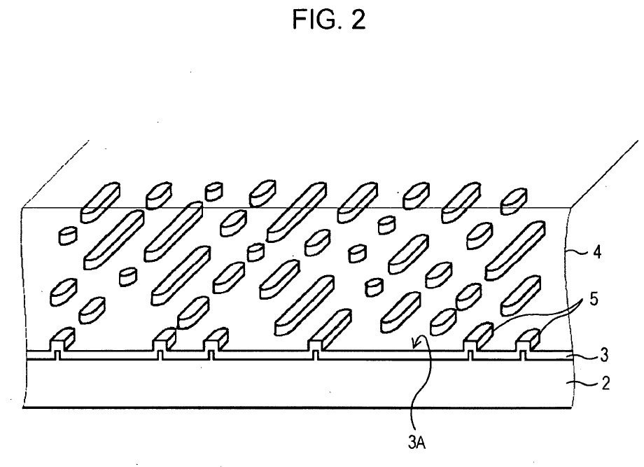

As shown in FIG. 2, in the optical disc 100C, it is assumed that a reflective recording layer 3 and a substrate 4 are provided on a cover substrate 2 on which raised pits 5 are formed and optical beams are applied from the substrate 4-side.

The reflective recording layer 3 reflects optical beams at a specific reflectance. When optical beams having a specific irradiation intensity are applied onto an information recording surface 3A, the reflectance of the information recording surface 3A is reduced and the code mark MK is thus formed.

The code mark MK is formed on the reflective recording layer 3 in such a manner that the code mark MK is not visible. Thus, the reflective recording layer 3 makes it unable for a third party to copy the code mark MK.

That is, on the information recording surface 3A, information can be recorded in accordance with two types of methods, namely, the raised form of the pits 5 and a change in the reflectance based on the code mark MK.

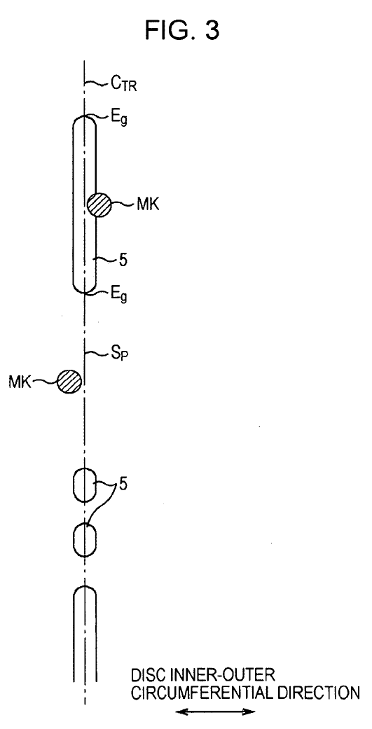

As shown in FIG. 3, the pits 5 are arranged substantially linearly. The code mark MK is formed so as to wobble and be displaced in a radial direction of the optical disc 100 (hereinafter, referred to as a disc inner-outer circumferential direction) with respect to a line (hereinafter, referred to as a track center line) C_{TR} connecting the centers of the pits 5.

Accordingly, the code mark MK can be formed in the optical disc 100 only by using a finishing device (code mark recording device) 6, which will be described later, configured to apply optical beams to a position displaced from the track center. Thus, a general optical disc device for recording information onto a CD-R or a CD-RW is not capable of forming the code mark MK.

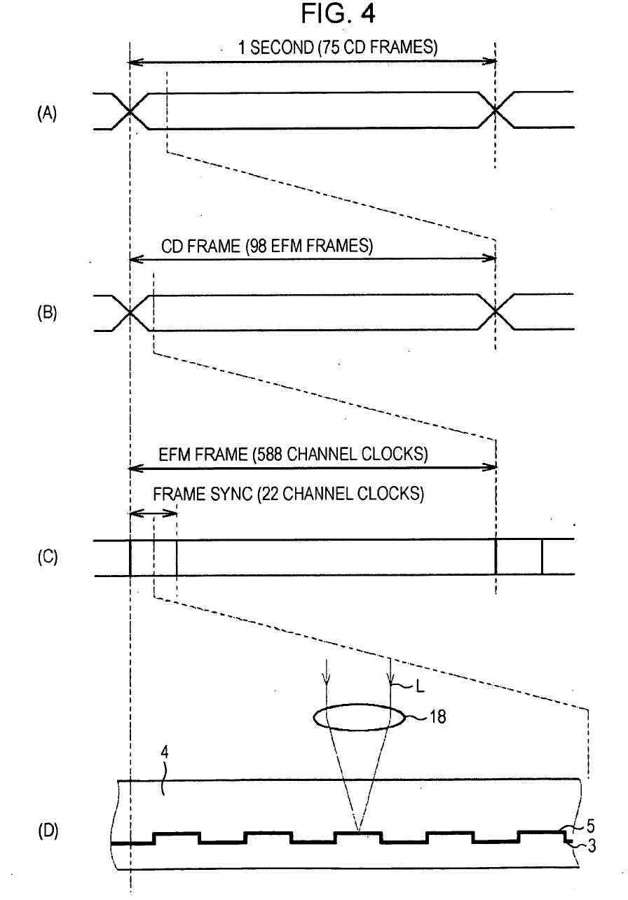

As shown in FIG. 4, in the optical disc 100C, as in a normal CD, 75 CD frames are allocated per second (see part (A) of FIG. 4), and 98 EFM frames are allocated to each CD frame (see part (B) of FIG. 4). In addition, each EFM frame is divided into 588 channel clocks, and a frame synch is allocated to the first 22 channel clocks of the 588 channel clocks.

The pits 5 and spaces Sp between the pits 5 on the track center line C_{TR} are repeated with lengths that are integral multiples of a reference length T, which represents a period of one channel clock. The frame sync is formed by a combination of a pit 5 and a space Sp each having a length of 11T.

Here, in general, the signal level of a reproduction signal generated on the basis of return optical beams reflected from a short pit having a length of 3T is small, whereas the signal level of a reproduction signal generated on the basis of return optical beams reflected from a long pit having a length of 4T or more is large.

In the optical disc 100C, the code mark MK is formed only for each of the midpoint of edges Eg of a pit 5 having a length of 11T and the midpoint of edges Eg of a space Sp having a length of 11T between pits 5, the pit 5 and the space Sp forming a frame sync. Thus, the length of each portion of each of the pit 5 and the space SP sandwiching a corresponding code mark MK can be set to a length of 4T or more. Thus, since the code mark MK at a reduced signal level can be recorded in a portion where the signal level of a reproduction signal is large, the code mark MK affects the reproduction signal as less as possible.

As described above, in the optical disc 100C, as well as the pits 5 representing main data, the code mark MK representing the modulated identification code EDr, which serves as sub-data, can be formed.

### (1-3) Production of Optical Disc

The substrate 4 of the optical disc 100C is produced by injection molding of polycarbonate or the like by using a stamper, as with normal CDs.

In the injection molding, the minute pits 5 having a recessed form are formed on the information recording surface 3A-side of the substrate 4 (see FIG. 2). Furthermore, in the optical disc 100C, for example, by vapor deposition, the reflective recording layer 3 that reflects optical beams L is formed on the information recording surface 3A-side of the substrate 4. Then, the cover substrate 2 for protecting the reflective recording layer 3 is formed.

Accordingly, as with normal CDs, main data represented by an audio signal and the like can be recorded on the optical disc 100C in accordance with repetition of the raised pits 5 and the spaces Sp. In addition, as shown in part (D) of FIG. 4, the optical beams L transmitted through the substrate 4 are reflected by the reflective recording layer 3, and main data can thus be reproduced on the basis of the reflected optical beams L.

Furthermore, by changing the reflectance of the reflective recording layer 3 by using the finishing device 6, the code mark MK representing the modulated identification code EDr is formed in the optical disc 100.

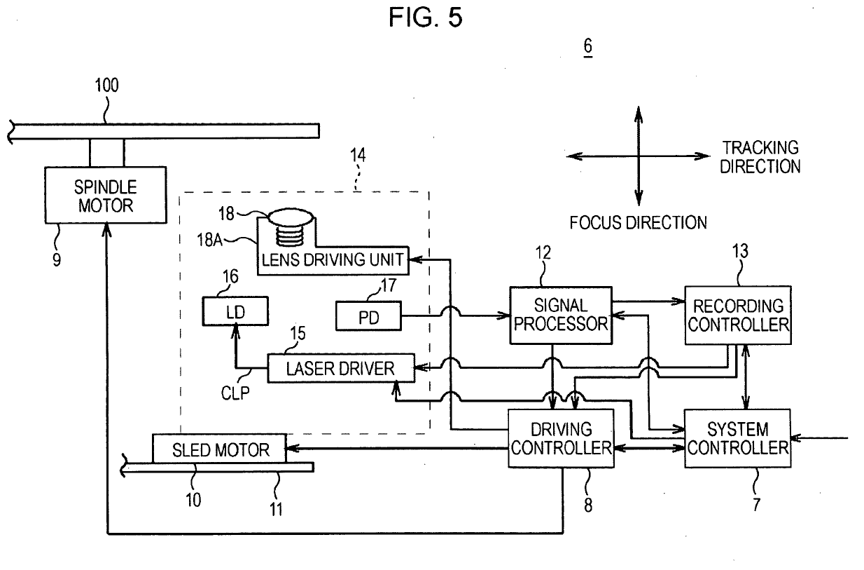

As shown in FIG. 5, the finishing device 6 is integrally controlled by a system controller 7 having the configuration of a computer. The system controller 7 is configured to perform recording processing for recording the code mark MK on the loaded optical disc 100C, in accordance with a user operation using an operation unit (not illustrated).

In the recording processing, the finishing device 6 irradiates the reflective recording layer 3 with the optical beams L at a relatively low emission light intensity to read main data, and detects a frame sync. Furthermore, when detecting a frame sync, the finishing device 6 instantaneously increases the emission light intensity of the optical beams L, so that the code mark MK is formed for each of the pit 5 and the space SP having a length of 11T, which represent the frame sync.

In the recording processing, the system controller 7 transmits a data writing instruction to a driving controller 8. In accordance with the data writing instruction from the system controller 7, the driving controller 8 controls a spindle motor 9 to rotate the optical disc 100C at a specific rotation speed, and controls a sled motor 10, on the basis of the data writing instruction and address information, to move an optical pickup unit 14 in the radial direction of the optical disc 100C along a guide shaft 11.

Then, the system controller 7 controls a laser driver 15 of the optical pickup unit 14 to cause a laser diode 16 to emit optical beams L to a track corresponding to the address information on the reflective recording layer 3 of the optical disc 100C, and an objective lens 18 collects the optical beams L and applies the collected optical beams L to the optical disc 100C.

Here, the optical pickup unit 14 receives, using a photo detector 17, reflected optical beams that are the optical beams L reflected by the optical disc 100C, and transmits a light reception signal corresponding to the amount of received light to a signal processor 12.

The signal processor 12 generates, on the basis of the light reception signal, a tracking error signal TE corresponding to the amount of displacement of the position where the optical beams L are applied with respect to a desired track and a focus error signal corresponding to the amount of displacement of the focal point of the optical beams L with respect to the reflective recording layer 3 of the optical disc 100C, and transmits the generated tracking error signal TE and the focus error signal to the driving controller 8. In addition, the signal processor 12 generates a reproduction signal RF on the basis of the light reception signal, and transmits the generated reproduction signal RF to a recording controller 13.

The driving controller 8 generates a tracking driving current and a focus driving current on the basis of the tracking error signal TE and the focus error signal, and outputs the tracking driving current and the focus driving current to a lens driving unit 18A. In accordance with them, the lens driving unit 18A drives the objective lens 18 in a tracking direction, which is the radial direction of the optical disc 100C, or in a focus direction, which is a direction in which the objective lens 18 approaches or recedes from the optical disc 100C, so that the focal point of the optical beams L can coincide with a desired track of the optical disc 100C.

The optical pickup unit 14 records, under the control of the laser driver 15, the code mark MK on the optical disc 100C by instantaneously applying optical beams L that have been adjusted to have an intensity suitable for recording, while applying optical beams L that have been adjusted to have an intensity suitable for reproduction.

As described above, the finishing device 6 is capable of recording the code mark MK, which represents the modulated identification code EDr, by causing the optical pickup unit 14 to apply optical beams that have been adjusted in such a manner that the optical beams are focused onto a desired track of the reflective recording layer 3 of the optical disc 100C at an emission light intensity corresponding to the reflective recording layer 3.

Here, the finishing device 6 detects a frame sync constituted by the pit 5 and the space Sp each having the length of 11T. In addition, by applying optical beams to a point that is displaced in the disc inner-outer circumferential direction from the track center line C_{TR}, the finishing device 6 is capable of forming the code mark MK so that the code mark MK can wobble in the disc inner-outer circumferential direction from the track center line C_{TR}.

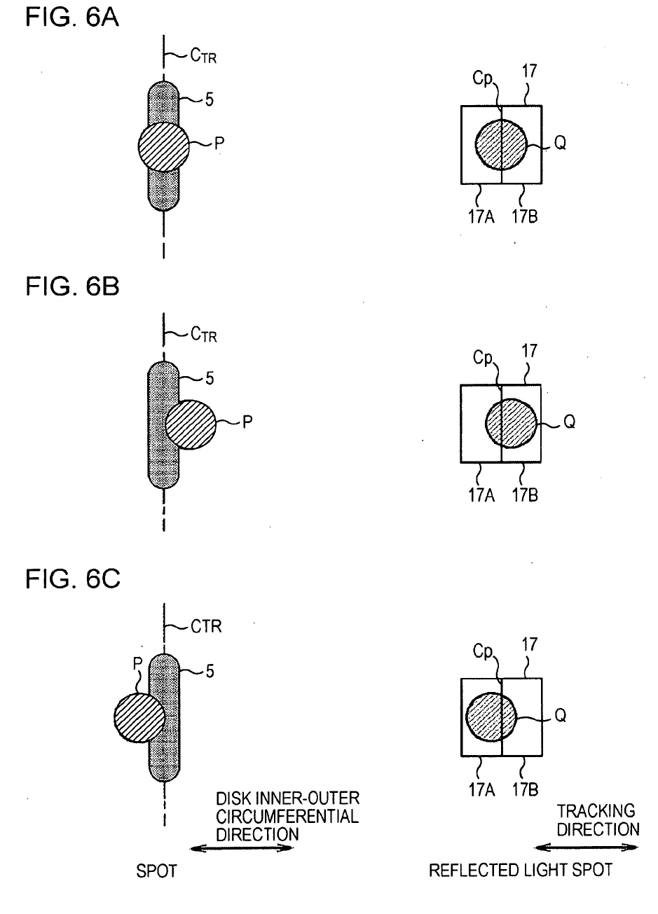

In the optical pickup unit 14, optical components are arranged in such a manner that when the optical beams L are applied to the track center line C_{TR}, the reflected optical beams are applied to the center of the photo detector 17. That is, as shown in FIG. 6A, when a spot P of the optical beams L is located at the track center line C_{TR}, a reflected light spot Q of the reflected optical beams is located at the center of the photo detector 17.

Here, since the light amounts of the reflected light spot Q received in detection areas 17A and 17B, which are opposite with respect to a division line Cp, are the same, the tracking error signal TE obtained on the basis of a difference between the light amounts in the detection areas 17A and 17B exhibits “0”.

In addition, as shown in FIGS. 6B and 6C, when the spot P is displaced in the disc inner-outer circumferential direction from the track center line C_{TR}, the reflected optical beams Q on the photo detector 17 are also displaced in the tracking direction corresponding to the disc inner-outer circumferential direction from the division line Cp. Here, the light amounts of the reflected light spot Q that are received in the detection areas 17A and 17B are different from each other. Thus, the tracking error signal TE does not exhibit “0”. That is, the tracking error signal TE exhibits a value corresponding to the amount of displacement of the spot P from the track center line C_{TR}.

In the finishing device 6 according to this embodiment, the recording controller 13 generates a desired position control signal HX representing the amount of displacement between the track center line C_{TR} and a desired application position, and supplies the generated desired position control signal HX to the driving controller 8. Then, by moving the objective lens 18 in the disc inner-outer circumferential direction under the control of the driving controller 8 so that the tracking error signal TE exhibits a value corresponding to the desired position control signal HX, the finishing device 6 applies the optical beams L to the desired application position that is displaced by a specific distance from the track center line C_{TR}. Accordingly, the finishing device 6 is capable of forming the code mark MK.

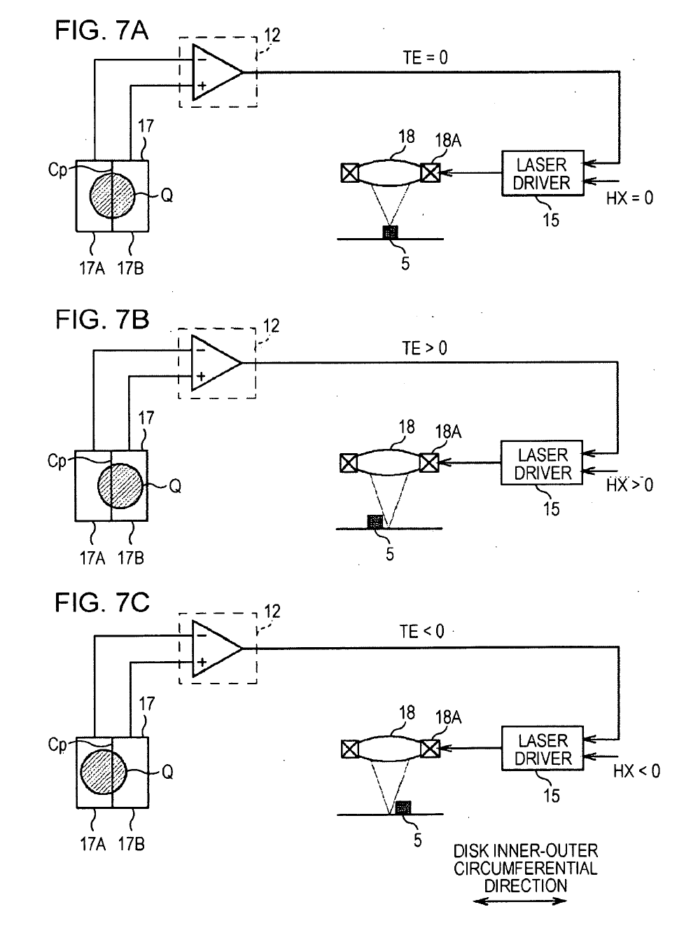

As shown in FIG. 7A, in a case where the voltage of the desired position control signal HX is “0”, which is a reference value, the driving controller 8 moves the objective lens 18 so that the tracking error signal TE exhibits “0”. Thus, the driving controller 8 is capable of applying the optical beams L to the track center line C_{TR}.

In addition, as shown in FIG. 7B, in a case where the desired position control signal HX exhibits a positive value, the driving controller 8 moves the objective lens 18 in the disc inner-outer circumferential direction, for example, outward, so that the tracking error signal TE exhibits a value corresponding to the desired position control signal HX. Thus, the driving controller 8 is capable of applying the optical beams L to a desired application position that is displaced from the track center line C_{TR} by an amount corresponding to the desired position control signal HX.

Similarly, as shown in FIG. 7C, in a case where the desired position control signal HX exhibits a negative value, the driving controller 8 moves the objective lens 18 in the disc inner-outer circumferential direction, for example, inward, so that the tracking error signal TE exhibits a value corresponding to the desired position control signal HX. Thus, the driving controller 8 is capable of applying the optical beams L to a desired application position that is displaced from the track center line C_{TR} by an amount corresponding to the desired position control signal HX.

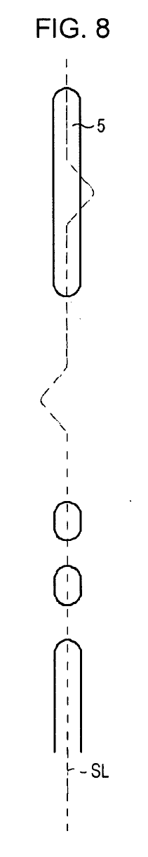

As described above, by moving the objective lens 18 on the basis of the desired position control signal HX, the finishing device 6 is capable of applying the optical beams L along a spot movement line SL that wobbles around the track center line C_{TR}, as shown in FIG. 8.

In addition, in the finishing device 6, the recording controller 13 generates an output signal MX, and supplies the output signal MX to the laser driver 15 of the optical pickup unit 14. In addition, by greatly increasing the emission light intensity of optical beams emitted from the laser diode 16 in accordance with the output signal MX under the control of the laser driver 15, the finishing device 6 forms the code mark MK at a desired position on the spot movement line SL.

That is, in a case where the code mark MK is not formed, the finishing device 6 applies the optical beams at a relatively small light emission intensity to the track center line C_{TR} in order to read information. Meanwhile, in a case where the code mark MK is formed, the finishing device 6 displaces the optical beams L from the track center line C_{TR} and instantaneously changes the reflectance of the reflective recording layer 3 by greatly increasing the emission light intensity of the optical beams L. Accordingly, the code mark MK is formed.

The configuration of the recording controller 13 for generating the desired position control signal HX and the output signal MX described above will now be described.

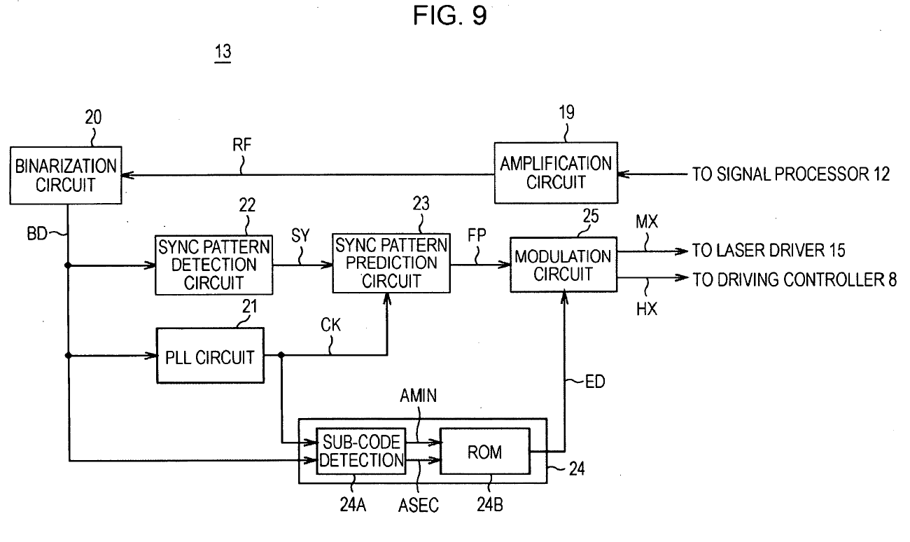

As shown in FIG. 9, an amplification circuit 19 amplifies a reproduction signal RF supplied from the signal processor 12 at a specific gain, and outputs the resultant reproduction signal RF to a binarization circuit 20. The binarization circuit 20 binarizes the reproduction signal RF output from the amplification circuit 19 at a specific reference level, and outputs a binarization signal BD to a phase-locked loop (PLL) circuit 21. The PLL circuit 21 reproduces a channel clock CK from the binarization signal BD.

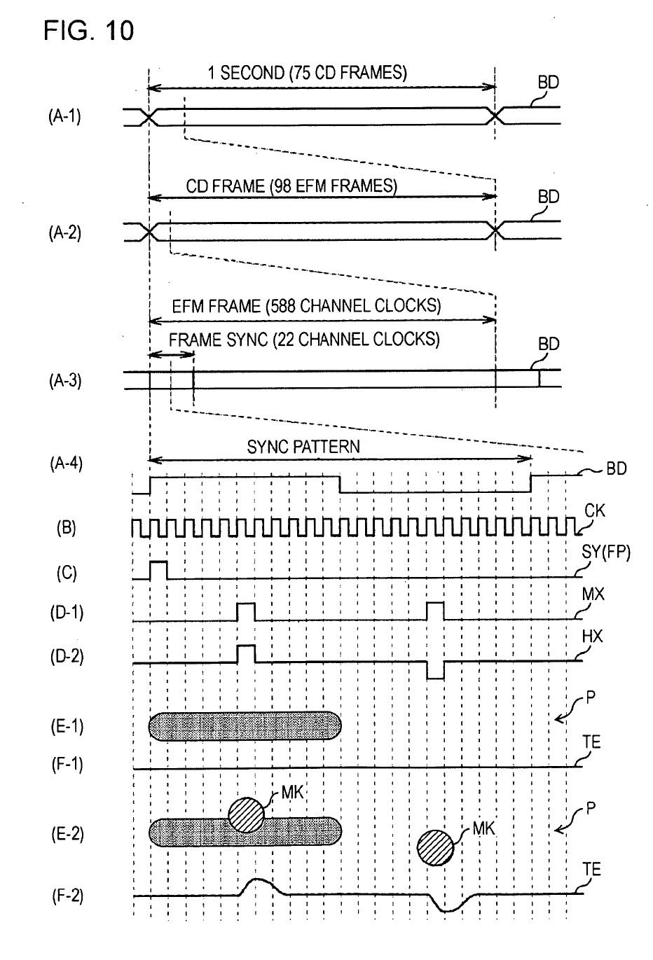

A synchronization pattern detection circuit 22 detects sync patterns which repeatedly occur in the binarization signal BD. That is, as shown in parts (A-1) to (A-4) of FIG. 10 corresponding to parts (A) to (C) of FIG. 4, the signal level of the binarization signal BD is switched in accordance with a pit sequence formed in the optical disc 100C. In addition, in a frame sync allocated at the beginning of each frame, the signal level rises during the time of 11T and then falls during the time of 11T.

A synch pattern detection circuit 22 (see FIG. 9) detects frame syncs by determining, by using flip-flop circuits which are connected together, the signal level of the binarization signal BD on the basis of the channel clock CK (see part (B) of FIG. 10). Furthermore, on the basis of the result of detection of a frame sync, the synch pattern detection circuit 22 outputs a sync pattern detection pulse SY whose signal level rises during the time T of one channel clock at the beginning of each frame (see part (C) of FIG. 10).

A sync pattern prediction circuit 23 includes a ring counter that counts channel clocks CK on the basis of the sync pattern detection pulse SY, and outputs a frame pulse FP whose signal level rises during the time T of one channel clock at the beginning of each frame (see part (C) of FIG. 10). Thus, even in a case where a frame sync is not correctly detected by the synch pattern detection circuit 22 due to a defect or the like, the sync pattern prediction circuit 23 predicts each frame sync and outputs a frame pulse FP.

A disc identification code generation circuit 24 includes a sub-code information detection circuit 24A and a read-only memory (ROM) 24B. The sub-code information detection circuit 24A decodes the binarization signal BD so that sub-code information contained in the binarization signal BD is reproduced. Furthermore, the disc identification code generation circuit 24 selectively outputs time information, such as minute information (AMIN) and second information (ASEC), from among time information on minute, second, and frame contained in the sub-code information.

Note that time information, such as minute information (AMIN) and second information (ASEC), is sub-code information defined by the specification of the optical disc 100C, and indicates the position of data on the optical disc 100C. That is, minute information (AMIN) represents data recorded on the optical disc 100C in units of minutes, and takes a value, for example, in a range from 0 to 74. In addition, second information (ASEC) defines, in more detail in units of seconds, a position that is defined in units of minutes by minute information (AMIN), and takes a value in a range from 0 to 59.

The ROM 24B holds the disc identification code ED, and outputs data stored in such a manner that time information, such as minute information (AMIN) and second information (ASEC), output from the sub-code information detection circuit 24A represents an address. Here, the disc identification code ED is constituted by ID information set as information unique to each disc, information on a manufacturing facility, the manufactured year, month, and date, information by which permission or inhibition of copying is controlled, and the like. The disc identification code ED also includes a synchronization signal representing the start of the disc identification code ED, an error-correcting code, and the like.

The ROM 24B holds the disc identification code ED as bit data, and outputs one bit of the disc identification code ED for an address based on minute information (AMIN) and second information (ASEC). Thus, the ROM 24B outputs one bit of the disc identification code ED per second.

A modulation circuit 25 supplies, as the desired position control signal HX, information oh an inward or outward displacement direction as the disc inner-outer circumferential direction and the amount of displacement, to the driving controller 8 (see part (D-2) of FIG. 10). In addition, the modulation circuit 25 modulates the disc identification code ED to generate the modulated identification code EDr, and supplies, to the laser driver 15, the output signal MX that rises at a timing corresponding to the modulated identification code EDr. Thus, in the finishing device 6, the amount of optical beams L is instantaneously increases, and the reflectance of the reflective recording layer 3 is thus locally changed. Accordingly, the code mark MK can be formed.

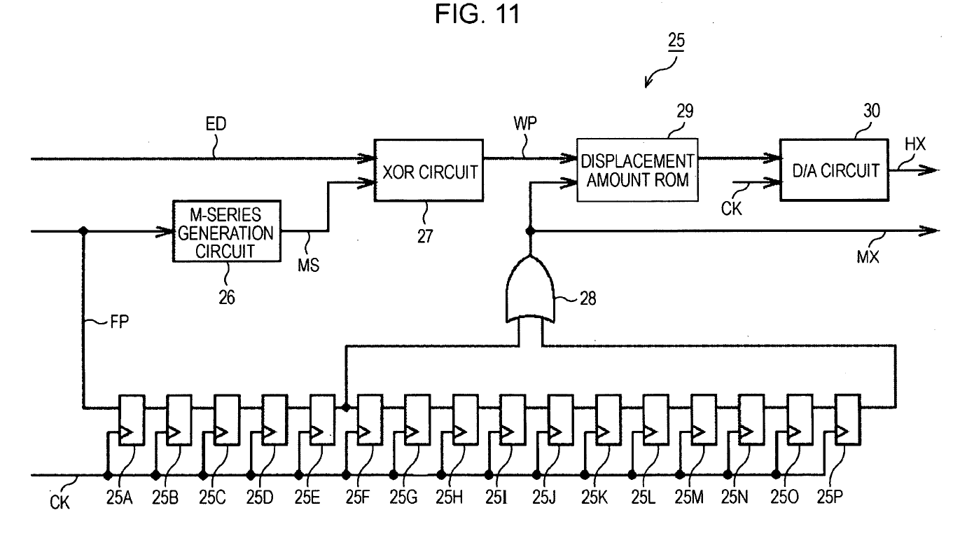

That is, as shown in FIG. 11, the modulation circuit 25 is constituted by an M-series generation circuit 26, which is a pseudo-random number series generator, a plurality of flip-flops 25A to 25P connected in cascade, and an exclusive-OR (XOR) circuit 27. The M-series generation circuit 26 sets an initial value of each of the plurality of flip-flops 25A to 25P in accordance with a timing corresponding to a change in second information (ASEC).

Furthermore, the M-series generation circuit 26 sequentially transfers the set details in synchronization with the frame pulse FP, and generates M-series random-number data MS in which logical “1” and logical “0” appear with the same probability by feedback between predetermined flip-flops. Thus, the M-series random-number data MS serves as a series of pseudo-random numbers in which the same pattern is repeated with a period corresponding to one bit of the disc identification code ED.

The exclusive-OR circuit 27 receives the M-series random-number data MS and the disc identification code ED, and outputs an exclusive logical OR signal WP to a displacement amount ROM 29. That is, in a case where the disc identification code ED is logical “0”, the exclusive-OR circuit 27 outputs the exclusive logical OR signal WP based on the logical level of the M-series random-number data MS. Meanwhile, in a case where the disc identification code ED is logical “1”, the exclusive-OR circuit 27 outputs the exclusive logical OR signal WP based on the inversion of the logical level of the M-series random-number data MS. As described above, the exclusive-OR circuit 27 modulates the disc identification code ED in accordance with an M-series random number.

The flip-flops 25A to 25P are connected in cascade. The frame pulse FP is input to the first flip-flop 25A. These flip-flops 25A to 25P sequentially transfer the frame pulse FP in synchronization with the channel clock CK.

An OR circuit 28 receives outputs from the fifth flip-flop 25E and the sixteenth flip-flop 25P, which is the last flip-flop, from among the flip-flops 25A to 25P, and outputs a logical OR signal indicating the logical OR of the outputs. Thus, the OR circuit 28 generates the output signal MX whose signal level rises during a one-channel-clock period T after a period of time corresponding to five channel clock CK periods has passed since the start of a frame sync and then rises during a one-channel-clock period T after a period of time corresponding to sixteen channel clock CK periods has passed since the start of the sync pattern (see part (D-1) of FIG. 10). Then, the OR circuit 28 supplies the generated output signal MX to the laser driver 15.

Consequently, the time during which the signal level of the output signal MX rises corresponds to a one-channel-clock period T that is the center of each of the pit 5 having the length of 11T and the space Sp having the length of T11 forming a sync pattern, and corresponds to a position separated from edges Eg of each of the pit 5 and the space Sp by a sufficient distance.

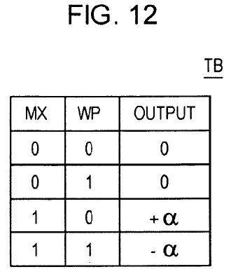

The displacement amount ROM 29 calculates the amount of displacement, by using the exclusive logical OR signal WP output from the exclusive-OR circuit 27 and the output signal MX of the OR circuit 28, with reference to an output table TB shown in FIG. 12. Then, the displacement amount ROM 29 supplies the obtained amount of displacement as the desired position control signal HX to a digital/analog (D/A) conversion circuit 30.

Referring to the output table TB shown in FIG. 12, “α” represents a control voltage for generating a distance of movement in the disc inner-outer circumferential direction. In addition, a positive value represents a disc inner circumferential direction, and a negative value represents a disc outer circumferential direction. In addition, “0” represents that the optical pickup unit 14 is located along the track center line C_{TR}. Then, the D/A conversion circuit 30 converts the desired position control signal HX into an analog signal, and supplies the obtained analog target position control signal HX to the driving controller 8. The driving controller 8 controls the lens driving unit 18A to move the objective lens 18 so that the spot P is moved in the disc inner-outer circumferential direction.

The laser driver 15 (see FIG. 5) switches the amount of optical beams L from an amount suitable for reproduction to an amount suitable for recording, in accordance with rising of the output signal MX. Here, the amount suitable for recording is an amount of light that is sufficient for changing the reflectance of the information recording surface 3A of the optical disc 100C.

Thus, the finishing device 6 moves the objective lens 18 in the disc inner-outer circumferential direction in accordance with the modulated identification code EDr modulated by the M-series random-number data MS at the midpoint between edges Eg of the pit 5 having the length of 11T and at the midpoint between edges Eg of a land (space Sp) having the length of 11T, which form a sync pattern. In addition, the finishing device 6 increases the amount of optical beams L, and additionally records the modulated identification code EDr.

Thus, in a case where the modulated identification code EDr is not additionally recorded on the optical disc 100C (see part (E-1) of FIG. 10), a tracking error signal TE having a signal waveform at an approximately reference value “0” is obtained for the pit 5 and the space Sp (see part (F-1) of FIG. 10). Meanwhile, in a case where the modulated identification code EDr is additionally recorded on the optical disc 100C (see part (E-2) of FIG. 10), a tracking error signal TE whose signal level locally changes in accordance with the characteristics of the reflective recording layer 3 is obtained in the vicinity of the center of each of the pit 5 and the space Sp (see part (F-2) of FIG. 10).

In a case where “p” represents the distance between pits 5 or between adjacent tracks in which the pits 5 are recorded and “D” represents the specific distance from the track center line C_{TR}, the finishing device 6 determines the value α, which is represented by the desired position control signal HX, so that the following expression is satisfied:

D≦p/4 (1)

As described above, since the finishing device 6 is capable of reducing a change in the signal level of the reproduction signal RF caused by formation of the code mark MK when the optical disc 100C is played back, the change in the signal level of the reproduction signal RF negligibly affects reproduction of main data.

### (1-4) Playback of Optical Disc

FIG. 13 is a block diagram showing the optical disc playback device 31 that plays back the optical disc 100C. In the optical disc playback device 31, a spindle motor 32 drives and rotates the optical disc 100C at a constant linear velocity under the control of a servo circuit 33.

An optical pickup unit 34 applies the optical beams L to the optical disc 100C. In addition, the optical pickup unit 34 receives reflected optical beams, which are obtained by reflection at the optical disc 100C, and outputs a reproduction signal RF whose signal level changes in accordance with the amount of reflected optical beams. Here, the modulated identification code EDr is recorded as the code mark MK on the optical disc 100C, and the reflectance is locally changed. Thus, the signal level of the tracking error signal TE changes in accordance with a change in the reflectance caused by formation of the code mark MK.

Note that since a change in the signal level of the tracking error signal TE, which corresponds to a change in the reflectance, is very small, the change in the signal level of the tracking error signal TE does not affect an operation of the optical pickup unit 14 of scanning over pits. Thus, an operation similar to a case where reflectance does not change can be performed.

A binarization circuit 35 binarizes the reproduction signal RF at a specific reference level to generate a binarization signal BD. A PLL circuit 36 operates on the basis of the binarization signal BD to reproduce a channel clock CCK of the reproduction signal RF.

An EFM demodulation circuit 37 sequentially latches binarization signals BD on the basis of the channel clock CCK to reproduce data corresponding to an EFM modulation signal S2 (not illustrated). Furthermore, after performing EFM demodulation of the reproduced data, the EFM demodulation circuit 37 divides the demodulated data in units of eight bits on the basis of a frame sync, performs de-interleaving of the obtained signal, and outputs the resultant signal to an error-correcting code (ECC) circuit 38.

The ECC circuit 38 performs error correction of the data output from the EFM demodulation circuit 37, on the basis of an error-correcting code signal added to the data output from the EFM demodulation circuit 37, to generate a main-data signal MD. Then, the ECC circuit 38 outputs the generated main-data signal MD to a digital/analog (D/A) conversion circuit 39.

The D/A conversion circuit 39 performs digital-to-analog conversion of the main-data signal MD output from the ECC circuit 38, and outputs an obtained main-data analog signal S4 to an external device (not illustrated).

In addition, a disc identification code reproducing circuit 41 demodulates the modulated identification code EDr in accordance with the tracking error signal TE supplied from the optical pickup unit 34, and supplies the obtained disc identification code ED to a system control circuit 40.

The system control circuit 40 is constituted by a computer for controlling operations of the optical disc playback device 31. For example, when reproducing processing is started, the system control circuit 40 controls the entire operation of the optical disc playback device 31 so that a specific area of the optical disc 100 is accessed.

Then, when the disc identification code ED is supplied from the disc identification code reproducing circuit 41, the system control circuit 40 determines, on the basis of the disc identification code ED, whether or not the correct modulated identification code EDr has been recorded on the optical disc 100C.

In a case where it is determined that the correct modulated identification code EDr has been recorded on the optical disc 100C and the optical disc 100C has been correctly produced, the system control circuit 40 continues to perform the reproducing processing. Meanwhile, in a case where it is determined that the correct modulated identification code EDr has not been recorded on the optical disc 100C and the optical disc 100C has been illegally copied by a third party, the system control circuit 40 controls the D/A conversion circuit 39 to stop outputting of the main-data analog signal S4.

That is, in a case where it is determined that the loaded optical disc 100C is an illegally copied, unauthorized optical disc 100X, the optical disc playback device 31 dose not play back the optical disc 100C.

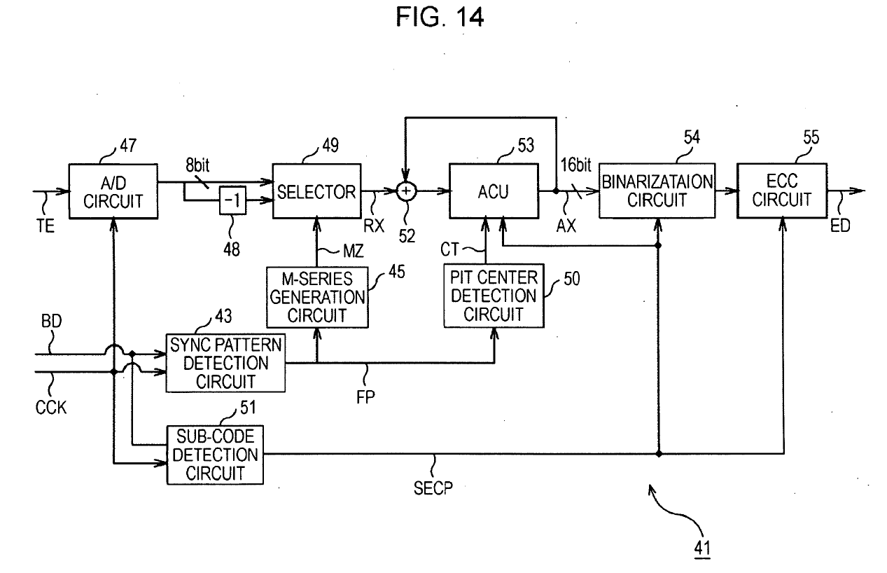

FIG. 14 is a block diagram showing the disc identification code reproducing circuit 41 that decodes the modulated identification code EDr and supplies the obtained code to the system control circuit 40.

In the disc identification code reproducing circuit 41, a sync pattern detection circuit 43 sequentially latches binarization signals BD on the basis of the channel clock CCK, and detects a sync pattern by sequentially determining the logical levels of the binarization signals BD. Furthermore, the sync pattern detection circuit 43 generates a frame pulse FP whose signal level rises during a one-channel-clock period T at the beginning of each frame on the basis of the detected sync pattern, and supplies the generated frame pulse FP to an M-series generation circuit 45 and a pit center detection circuit 50.

The M-series generation circuit 45 initializes an address at a specific timing under the control of the system control circuit 40. Furthermore, the M-series generation circuit 45 sequentially advances the address in accordance with the frame pulse FP to access an internal read-only memory (ROM), and generates M-series random-number data MZ corresponding to the M-series random-number data MS generated by the finishing device 6. Then, the M-series generation circuit 45 supplies the generated M-series random-number data MZ to a selector 49.

An analog/digital (A/D) conversion circuit 47 performs analog/digital conversion of the tracking error signal TE to generate an 8-bit digital TE signal on the basis of the channel clock CCK, and supplies the 8-bit digital TE signal to the selector 49 and to a polarity inversion circuit (−1) 48. The polarity inversion circuit (−1) 48 inverts the polarity of the digital TE signal, and supplies the obtained signal to the selector 49.

In accordance with the logical level of the M-series random-number data MZ output from the M-series generation circuit 45, the selector 49 selects a digital TE signal directly input from the A/D conversion circuit 47 or a digital TE signal whose polarity has been inverted by the polarity inversion circuit (−1) 48, and supplies the selected digital TE signal to an adder 52.

That is, in a case where the M-series random-number data MZ is logical “1”, the selector 49 selects and outputs the directly input digital TE signal. Meanwhile, in a case where the M-series random-number data MZ is logical “0”, the selector 49 selects the digital TE signal whose polarity has been inverted. Thus, the selector 49 reproduces the logical level of the disc identification code ED modulated in accordance with the M-series random-number data MS as multi-level data, and outputs the multi-level data as reproduction data RX.

As with the modulation circuit 25 in the finishing device 6, the pit center detection circuit 50 is constituted by sixteen flip-flops connected in cascade (not illustrated) and an OR circuit for receiving outputs of specific flip-flops. The pit center detection circuit 50 sequentially transfers, via the flip-flops, a frame pulse FP, and thus supplies to an accumulator (ACU) 53 a center detection signal CT whose signal level rises during a one-channel-clock period T at the center of a pit having a length of 11T and a land having a length of 11T.

A sub-code information detection circuit 51 monitors the binarization signal BD on the basis of the channel clock CCK, and obtains sub-code information by decoding the binarization signal BD. Furthermore, the sub-code information detection circuit 51 monitors time information within the obtained sub-code information, generates a one-second detection pulse SECP whose signal level rises every time the time information changes in every second, and supplies the one-second detection pulse SECP to each of a binarization circuit 54 and an ECC circuit 55.

The adder 52 is a 16-bit digital adder. The adder 52 adds reproduction data RX to data AX output from the accumulator 53, and supplies the sum to the accumulator 53. The accumulator 53 is constituted by a 16-bit memory for holding data output from the adder 52. The accumulator 53 feeds back the held data to the adder 52, and thus forms an accumulating device, together with the adder 52.

That is, after clearing the held contents in accordance with the one-second detection pulse SECP, the accumulator 53 records data output from the adder 52 at a timing based on the center detection signal CT. Thus, the adder 52 accumulates logical values of the reproduction data RX reproduced by the selector 49 every second in accordance with time information based on the sub-code information (during a time corresponding to 7350 frames), and supplies the accumulated value AX to the binarization circuit 54.

The binarization circuit 54 binarizes the data AX output from the accumulator 53 on the basis of a specific reference value at a timing when the one-second detection pulse SECP rises, and supplies the binarized output data to the ECC circuit 55. Thus, the reproduction data RX of the disc identification code ED reproduced by the selector 49 is converted into binary disc identification code ED.

The ECC circuit 55 performs error correction of the disc identification code ED on the basis of the error-correcting code added to the disc identification code ED, and supplies the resultant disc identification code ED to the system control circuit 40.

Then, the system control circuit 40 determines, on the basis of the disc identification code ED, whether or not the optical disc 100C has been produced in an authorized manner. Only in a case where it is determined that the optical disc 100C has been produced in an authorized manner, the system control circuit 40 continues to perform the reproducing processing.

As described above, for starting of reproducing processing, the optical disc playback device 31 reads modulated identification code EDr recorded as a code mark MK in a specific area of the optical disc 100C. In addition, the optical disc playback device 31 generates disc identification code ED on the basis of the modulated identification code EDr, and thus is capable of determining whether or not the optical disc 100C has been produced in an authorized manner.

### (1-5) Conclusion

In a producing process of the optical disc 100C according to this embodiment, a mother disc is produced by a normal mastering device, and the substrate 4 is produced by using a stamper produced from the mother disc. Furthermore, the reflective recording layer 3 and the cover substrate 2 are formed on the substrate 4 so that the optical disc 100C can be produced (see FIG. 2). Thus, the pits 5 as recording marks having lengths that are integral multiples of a reference length corresponding to a specific reference time T and spaces Sp are repeated in the optical disc 100C, and a digital audio signal and the like are recorded as main data.

Here, in the optical disc 100C, a film structure similar to that of an information recording surface of a CD-R is applied to the reflective recording layer 3. Thus, when optical beams L are applied at a specific light intensity or more, the reflectance of the reflective recording layer 3 in a position where the optical beams L are applied reversibly changes. Accordingly, in addition to the main data recorded by repetition of the pits 5 and the spaces Sp, sub-data can be additionally recorded.

In the finishing device 6 (see FIG. 5), a specific area of the optical disc 100C, which has been produced as described above, is reproduced under the control of the system controller 7, and the disc identification code ED in the state after being modulated is recorded in the specific area in such a manner that no influence is exerted on reproduction of the digital audio signal and the like, which have been recorded as main data by repetition of the pits 5 and the spaces Sp.

That is, in the finishing device 6, the reproduction signal RF obtained from the optical pickup unit 14 is converted by the binarization circuit 20 into a binarization signal BD, and the synch pattern detection circuit 22 detects a sync pattern from the binarization signal BD. Thus, timings when a pit 5 and a space Sp each having a length of 11T, which is the longest among the pits 5 and the spaces Sp formed in the optical disc 100C, start are detected.

Furthermore, the sync pattern prediction circuit 23 generates a frame pulse FP whose signal level rises at a timing when a sync pattern starts. Thus, even in a case where a binarization signal BD is not correctly reproduced due to a defect or the like, the timings when the pit 5 and the space Sp having the length of 11T start can be correctly detected.

Furthermore, in the modulation circuit 25 (see FIG. 11), the flip-flops 25A to 25P sequentially transfer the frame pulse FP. Outputs from the fifth flip-flop and the sixteenth flip-flop are combined together by the OR circuit 28. Thus, a one-channel-clock period T in a central portion of the pit 5 having the length of 11T and a one-channel-clock period T in a central portion of the space Sp having the length of 11T are detected.

In association with them, in the sub-code information detection circuit 24A (see FIG. 9), sub-code information is reproduced. Then, information identifying a reproduction position based on minute information (AMIN) and second information (ASEC) is detected in accordance with the sub-code information. Then, the ROM 24B outputs disc identification code ED corresponding to the information identifying the reproduction position. Here, since the ROM 24B holds the disc identification code ED in accordance with bit information and outputs the held disc identification code ED accessed in accordance with the minute information (AMIN) and the second information (ASEC), the disc identification code ED is output at a significantly low bit rate, that is, 1 bit per second.

In addition, the M-series generation circuit 26 generates, in synchronization with the frame pulse FP, M-series random-number data MS in which logical “1” and logical “0” appear with the same probability. Then, the exclusive-OR circuit 27 modulates the disc identification code ED on the basis of the M-series random-number data MS. Furthermore, the optical pickup unit 14 is moved in the disc inner-outer circumferential direction in accordance with a D/A output, while the displacement amount ROM 29 is referred to by using an output from the exclusive-OR circuit 27 and an output signal MX from the OR circuit 28. In addition, an output from the OR circuit 28 serves as an output signal MX whose signal level rises in a central portion of each of a pit 5 and a space Sp having a length of 11T.

The optical disc 100C is moved in the disc inner-outer circumferential direction in accordance with the desired position control signal HX and the output signal MX. In addition, the amount of optical beams L is increased so that the reflectance of the reflective recording layer 3 is locally changed. Thus, a code mark MK, which is a local, very small mark, is formed in a position that is in a central portion of each of the pit 5 and the space Sp having the length of 11T and that is displaced in the disc inner-outer circumferential direction.

The code mark MK is formed in the vicinity of the midpoint between edges of the pit 5 having the length of 11T and in the vicinity of the midpoint between edges of the space Sp having the length of 11T in such a manner that the code mark MK is displaced from the track center line C_{TR}. As a result, the signal level of a reproduction signal RF that changes in accordance with the pit 5 and the space Sp is held similarly, both in a case where the code mark MK is formed and a case where the code mark MK is not formed. Thus, modulated identification code EDr, which is sub-data, can be recorded without influencing reproduction of main data represented by the pits 5 and the spaces Sp.

That is, in a case where “NA” represents the number of apertures of an optical system that reproduces data represented by pit sequences of this type and “A” represents the wavelength of an optical beam L, a spot P having a diameter of D1 represented by the following equation can be formed:

$$D 1 = \frac{1.22 \times λ}{NA} , \qquad ( 2 )$$

where the diameter D1 represents a half-width of the spot P.

Thus, if the code mark MK is formed in a position separated from the preceding and succeeding edges Eg by a distance of D1, scanning of the code mark MK and scanning of the edges Eg are not performed at the same time in the spot P. Meanwhile, positional information of an edge Eg represents a timing when the signal level of the reproduction signal RF reaches a threshold, which represents the average level of the reproduction signal RF. This timing corresponds to a timing when the center of the spot P reaches the edge Eg. In this timing, in a case where the optical beams L are not applied to the edge Eg and the code mark MK at the same time, the timing when the threshold is reached is held as in a case where the code mark MK is not formed.

Thus, as shown by equation (3), where the diameter D1 in equation (2) is divided by two, by forming a mark in a position separated by a distance of D1 from the preceding and succeeding edges Eg, modulated identification code EDr, which is sub-data, can be reproduced, without influencing reproduction of main data represented by the pits 5 and the spaces Sp.

$$D 1 = \frac{1.22 \times λ}{2 \times NA} \qquad ( 3 )$$

In general, since the number NA of apertures in the optical disc playback device 31 that plays back the optical disc 100C is 0.45 and the wavelength λ is 0.78 [μm], a value D=1.06 [μm] can be obtained from equation (3). Since the optical disc 100C rotates at a linear velocity of 1.2 [μm/sec] and the frequency of a channel clock CK is 4.3218 [MHz], in a case where the code mark MK is formed in a position that is separated from an edge Eg by a distance corresponding to four channel clock periods, the position where the code mark MK is formed is separated from the edge Eg by the distance D1 or more, in accordance with equation (3).

That is, by forming the code marks MK in positions that are separated from edges Eg of the pits 5 and the spaces Sp by a distance corresponding to a length of about 4T or more, edge information on the edges Eg of the pits 5 and the spaces Sp and mark information on the code marks MK, which are detected in a similar manner in accordance with a change in the amount of reflected optical beams, can be reproduced separately. Thus, modulated identification code EDr, which is sub-data, can be recorded, without influencing reproduction of main data represented by the pits 5 and the spaces Sp.

In addition, since disc identification code ED is modulated in accordance with M-series random-number data MS in which logical “1” and logical “0” appear with the same probability and is recorded, a change in the tracking error signal TE based on a change in the reflectance is detected as being noise intrusion during a tracking error. Thus, it is difficult to find the modulated identification code EDr in the tracking error signal TE. Consequently, it is difficult to copy the modulated identification code EDr.

In addition, since one bit of the modulated identification code EDr is allocated for a period of one second, that is, since one bit is recorded for a total of 7350 (=75×98) CD frames in a dispersed manner, the modulated identification code EDr can be reliably reproduced even if the reproduction signal RF varies due to noise or the like.

In addition, in the optical disc 100C on which the modulated identification code EDr is recorded as described above, although main data represented by pit sequences can be copied relatively easily by using a technique of illegal copying, it is difficult to copy sub-data (modulated identification code EDr) represented by the code mark MK.

That is, in the case of the optical disc 100, it is necessary for a third party who tries to produce an illegally copied optical disc to record the modulated identification code EDr represented by the code mark MK, as with the optical disc 100C. Thus, it is necessary for the third party to prepare an optical disc on which main data is recorded in advance on the basis of pit sequences and which has the reflective recording layer 3. In addition, it is necessary for the third party to prepare a device having a configuration similar to that of the finishing device 6. Thus, the optical disc 100C is capable of making it difficult for a third party to produce an unauthorized optical disc 100X.

The optical disc playback device 31 receives, with the photo detector 17 having the two detection areas 17A and 17B, reflected optical beams obtained by applying optical beams L to the optical disc 100C produced as described above. In addition, the optical disc playback device 31 generates a reproduction signal RF whose signal level changes in accordance with the amount of received reflected optical beams, and the binarization circuit 35 binarizes the reproduction signal RF. Then, the optical disc playback device 31 performs, with the EFM demodulation circuit 37, binary identification of the binarization signal BD. After that, the optical disc playback device 31 performs EFM demodulation and de-interleaving processing. Then, the optical disc playback device 31 performs, with the ECC circuit 38, error correction, and reproduces the main-data signal MD, which represents main data.

Here, in the optical disc 100C, a code mark MK, which is formed by a local change of reflectance, is formed in a central portion of a pit 5 and a space Sp each having a length of 11T in such a manner that the code mark MK is located in a position separated from preceding and succeeding edges Eg of each of the pit 5 and the space Sp by a distance corresponding to a length of 4T or more. Thus, a change in the signal level of the reproduction signal RF in the vicinity of each of the edges Eg, which is caused by formation of the code mark MK, can be prevented. Consequently, even in the case of the optical disc 100C having the disc identification code ED recorded thereon, information recorded on the basis of the pits 5 can be correctly reproduced by using the optical disc playback device 31, which is a normal CD player.

Furthermore, before the main-data signal MD is reproduced as described above, the optical disc playback device 31 accesses a specific area of the optical disc 100C to reproduce the disc identification code ED in accordance with the area. Here, in a case where the disc identification code ED is not, correctly obtained by decoding, the optical disc playback device 31 determines that illegal copying has been performed and controls the D/A conversion circuit 39 to stop performing digital/analog conversion.

That is, the optical disc playback device 31 reads the modulated identification code EDr from the optical disc 100C and detects, with the sync pattern detection circuit 43, a frame sync. Then, the optical disc playback device 31 generates, with the M-series generation circuit 45, M-series random-number data MZ corresponding to M-series random-number data MS at the time of recording, on the basis of the detection of a frame sync.

In addition, the optical disc playback device 31 generates a tracking error signal TE whose signal level changes in accordance with a difference between the amounts of reflected optical beams in the detection areas 17A and 17B, converts, with the A/D conversion circuit 47, the tracking error signal TE into a digital TE signal, and selects, with the selector 49, the digital TE signal or a digital TE signal whose polarity has been inverted, with reference to the M-series random-number data MZ. Thus, data RX which represents the logical level of the disc identification code ED by using multi-level data is reproduced.

The optical disc playback device 31 accumulates, with the accumulator 53 and the adder 52, the reproduction data RX, in units of seconds. Thus, an improved signal-to-noise ratio can be achieved. In addition, in the optical disc playback device 31, after the accumulated results are binarized by the binarization circuit 54 and the disc identification code ED is obtained by decoding, the ECC circuit 55 performs error correction and outputs the resultant code to the system control circuit 40. Consequently, the optical disc playback device 31 is capable of obtaining the disc identification code ED from the code mark MK recorded on the optical disc 100C, and thus is capable of determining whether or not the optical disc 100C has been produced in an authorized manner.

### (1-6) Operations and Advantages

In the configuration described above, the finishing device 6 applies the optical beams L to a desired application position that is displaced by a desired distance in the disc inner-outer circumferential direction from the center of each of the pits 5 and the spaces SP having a length of 11T, which is maximum, of the optical disc 100C on which a main-data sequence is recorded in advance by forming the pits 5 serving as recording marks and the spaces Sp having lengths corresponding to the main-data sequence on the track center line C_{TR} of the information recording surface 3A, and thus locally changes the reflectance of the information recording surface 3A, so that the code marks MK can be formed. Consequently, the modulated identification code EDr serving as a sub-data sequence is recorded on the optical disc 100C.

Thus, the finishing device 6 is capable of recording the modulated identification code EDr on the optical disc 100C in such a manner that it is difficult to illegally copy the optical disc 100C. Therefore, producing an unauthorized optical disc 100X on the basis of the optical disc 100C can be avoided in advance.

That is, in order to form the code mark MK in a desired application position that is displaced from the track center line C_{TR} by a desired distance, it is necessary for the finishing device 6 to have a mechanism for applying the optical beams L to the desired application position. It is difficult to produce a device having a configuration similar to that of the finishing device 6, for example, by reconstructing a general optical disc device. Thus, compared with a method for forming a code mark MK on the track center line C_{TR}, illegal copying by a third party can be avoided more effectively.

The finishing device 6 includes the laser diode 16 serving as a light source that emits the optical beams L, the objective lens 18 that collects the optical beams L and applies the collected optical beams to the optical disc 100C, the lens driving unit 18A that serves as an objective lens driving unit for driving the objective lens 18, and the recording controller 13 that controls the lens driving unit 18A to apply the optical beams L to a desired application position and controls the laser diode 16 so that the emission light intensity of the optical beams L applied to the desired application position is greatly increased, on the basis of reflected optical beams that are the optical beams L reflected by the optical disc 100C.

Thus, the finishing device 6 is capable of applying the optical beams L at a sufficient emission light intensity to the desired application position that is displaced from the track center line C_{TR} by a desired distance, so that the code mark MK can be formed in the desired application position.

With the configuration described above, by applying the optical beams L to a desired application position that is displaced from the track center line C_{TR} by a desired distance of the optical disc 100C on which a main-data sequence is recorded in advance as a pit sequence on the information recording surface 3A, the finishing device 6 is capable of forming the code mark MK representing a sub-data sequence on the information recording surface 3A in such a manner that it is difficult to copy the code mark MK. Thus, the finishing device 6 is capable of recording two types of data sequences on the information recording surface 3A on which a sub-data sequence is recorded. In addition, the finishing device 6 is capable of making it difficult for a third party to illegally copy the optical disc 100C. Consequently, an optical disc recording device, a recording method, an optical disc, and an optical disc playback device that make it difficult to produce an optical disc on which illegally copied data is recorded can be realized.

### Second Embodiment

### (2-1) Configuration of Finishing Device

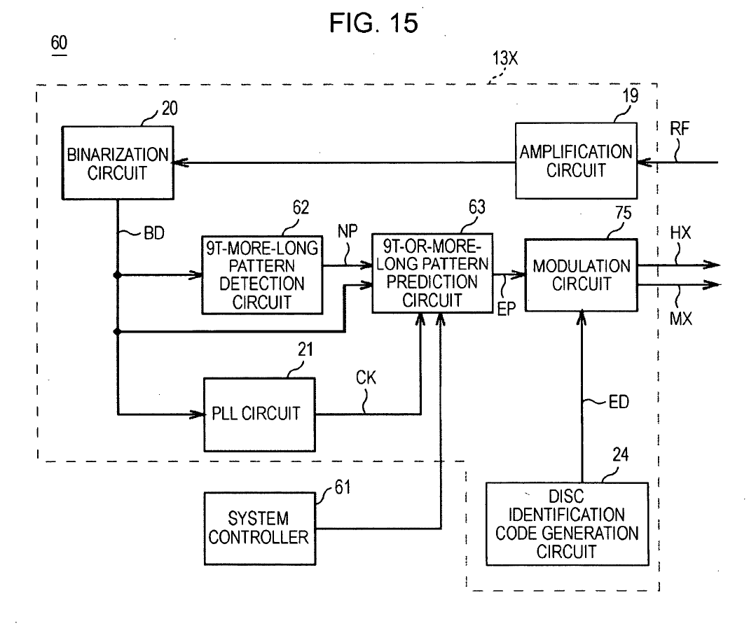

In a second embodiment described with reference to FIGS. 15 to 17, parts corresponding to those in the first embodiment described above with reference to FIGS. 1 to 14 are denoted by the same reference numerals and signs. A finishing device (code mark recording device) 60 according to the second embodiment is different from the finishing device 6 according to the first embodiment in that the finishing device 60 detects pits 5 each having a length of 9T or more and the modulated identification code EDr is recorded for each of the detected pits 5.

That is, the finishing device 60 has a configuration similar to that of the finishing device 6 shown in FIG. 5. In addition, a system controller 61 corresponding to the system controller 7 controls the entire finishing device 60. The system controller 61 controls the operation of the optical pickup unit 14 on the basis of sub-code information detected from the reproduction signal RF, and sequentially traces, twice by using the optical pickup unit 14, an area set as the area where the modulated identification code EDr is to be recorded.

The system controller 61 holds a trace signal T1 at logical “0” in the first tracing, whereas the system controller 61 switches the logical level of the trace signal T1 into logical level “1” in the second tracing where a portion that has been subjected to scanning by the first tracing is scanned again. Note that the first tracing is performed in order to detect a pit 5 having a length of 9T or more and the second tracing is performed in order to additionally record disc identification code for the pit 5 having the length of 9T or more in accordance with a result of the detection.

As shown in FIG. 15, in the first tracing, a 9T-or-more-long pattern detection circuit 62 of a recording controller 13X detects a pit having a length of 9T or more by detecting a pulse width of nine channel clock periods 9T or more.

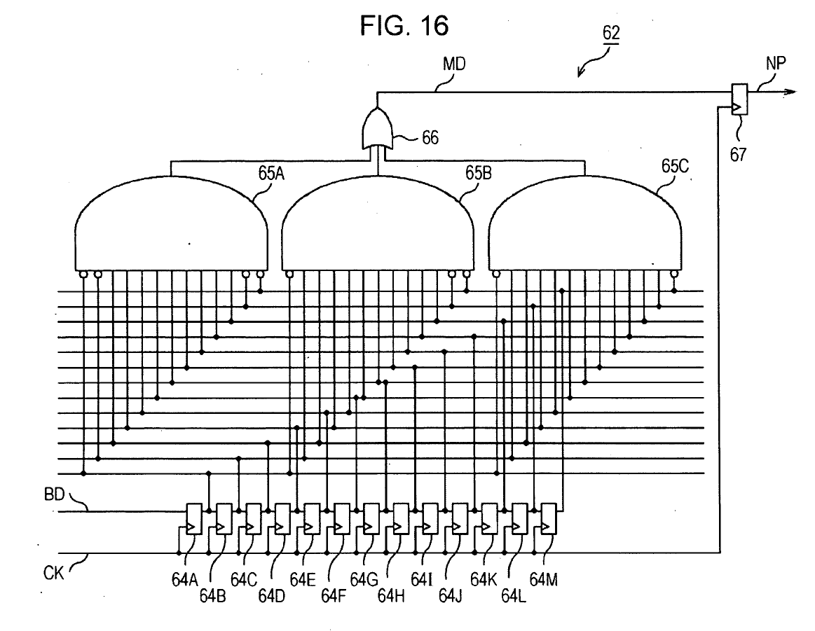

That is, as shown in FIG. 16, the 9T-or-more-long pattern detection circuit 62 includes thirteen flip-flops 64A to 64M that are connected in cascade, and a binarization signal BD output from the binarization circuit 20 is input to the first flip-flop of the flip-flops 64A to 64M. The flip-flops 64A to 64M sequentially transfer input data in synchronization with a channel clock CK.

AND circuits 65A to 65C each receive outputs from all the flip-flops 64A to 64M and output a logical AND signal. Here, the AND circuit 65A receives the outputs from the flip-flops 64A to 64M, while the logical levels of the outputs from the first flip-flop 64A, the second flip-flop 64B, the twelfth flip-flop 64L, and the last flip-flop 64M are inverted. Thus, in a case where outputs “0011111111100” are obtained, that is, in a case where consecutive logical levels corresponding to the form of a pit having a length of 9T are obtained, the logical level of the logical AND signal rises.

Then, the AND circuit 65B receives the outputs from the flip-flops 64A to 64M, while the logical levels of the outputs from the first flip-flop 64A, the twelfth flip-flop 64L, and the last flip-flop 64M are inverted. Thus, in a case where outputs “0011111111110” are obtained, that is, in a case where consecutive logical levels corresponding to the form of a pit having a length of 10T are obtained, the logical level of the logical AND signal rises.

The AND circuit 65C receives the outputs from the flip-flops 64A to 64M, while the logical levels of the outputs from the first flip-flop 64A and the last flip-flop 64M are inverted. Thus, in a case where outputs “0111111111110” are obtained, that is, in a case where consecutive logical levels corresponding to the form of a pit having a length of 11T are obtained, the logical level of the logical AND signal rises.

An OR circuit 66 calculates the logical OR of output signals output from the AND circuits 65A to 65C. In a case where a pit having a length of 9T, 10T, or 11T is detected, the OR circuit 66 supplies a logical OR signal MD which exhibits logical “1” to a flip-flop 67. The flip-flop 67 samples the logical OR signal MD on the basis of a channel clock CK, and removes the influence of glitch noise or the like by performing waveform shaping. Then, the flip-flop 67 supplies a detection pulse NP to a 9T-or-more-long pattern prediction circuit 63.

The 9T-or-more-long pattern prediction circuit 63 (see FIG. 15) switches its operation in accordance with the logical level of the trace signal T1 output from the system controller 61. Thus, in the first tracing, positional information on a pit having a length or 9T or more is recorded. Meanwhile, in the second tracing, a timing signal EP for recording the modulated identification code EDr is output on the basis of the recorded positional information.

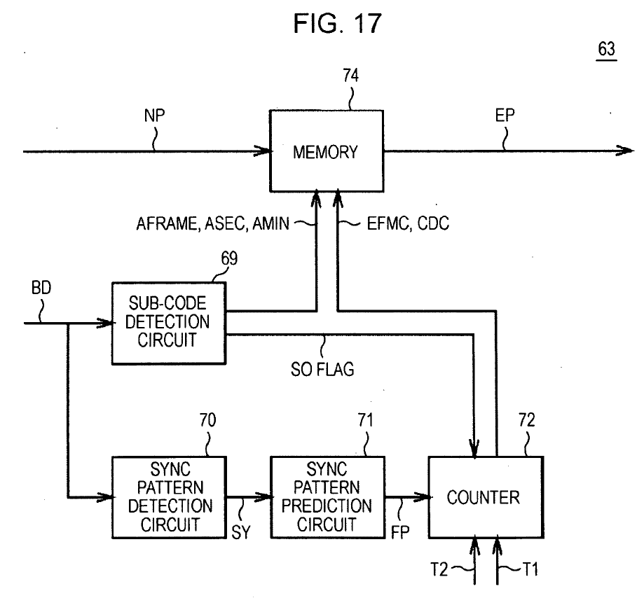

That is, as shown in FIG. 17, in the 9T-or-more-long pattern prediction circuit 63, a sub-code information detection circuit 69 processes the binarization signal BD on the basis of the channel clock CK, so that positional information (frame information (AFRAME), second information (ASEC), and minute information (AMIN)) on the optical disc 100C recorded as sub-code information is reproduced. Here, the frame information (AFRAME) is positional information in which one second is equally divided into 75 frames. In addition, the sub-code information detection circuit 69 decodes an S0 flag (formed by a sync pattern of sub-coding) contained in the sub-code information, and supplies a sub-code information flag S0FLAG indicating one frame of the sub-code information to a counter 72.

A sync pattern detection circuit 70 detects a sync frame by monitoring consecutive logical levels of the binarization signal BD on the basis of the channel clock CK, and supplies to a sync pattern prediction circuit 71 a sync frame detection signal SY whose signal level rises at the beginning of each frame.

The sync pattern prediction circuit 71 is constituted by a ring counter configured to count channel clocks on the basis of the sync frame detection signal SY. Thus, even in a case where the sync pattern detection circuit 70 does not detect a sync frame due to a defect or the like, a complete frame pulse FP can be transmitted to the counter 72 by using the periodicity of sync frames.

The counter 72 is constituted by a ring counter configured to count up channel clocks CK on the basis of the frame pulse FP. Thus, a count value EFMC represented by positional information in which one EFM frame is divided into 588 frames is supplied to a memory 74. Furthermore, the counter 72 counts up frame pulses FP on the basis of the sub-code information flag S0FLAG. Thus, the counter 72 generates a count value CDC represented by positional information in which one CD frame is equally divided into 98 frames, and supplies the count value CDC to the memory 74.

When supplying the count values EFMC and CDC to the memory 74, in a case where the trace signal T1 exhibits logical “0” (that is, in the first tracing), the counter 72 counts up sequential channel clocks CK so that the count value EFMC exhibits 0 at a timing when the frame pulse FP rises. Meanwhile, in a case where the trace signal T1 exhibits logical “1” (that is, in the second tracing), the counter 72 counts up the sequential channel clocks CK so that the count value EFMC exhibits 7 at a timing when the frame pulse FP rises.

Here, seven channel clock CK periods, which correspond to the value “7”, correspond to a delay time from outputting of the timing signal EP based on the count value EFMC to increasing of the amount of optical beams L in an application position of the optical beams L identified by the count value EFMC. Thus, in the second tracing, the counter 72 counts up the channel clocks CK so that the count value EFMC is counted up during the delay time.

The memory 74 is constituted by a memory configured to record a detection pulse NP in accordance with addresses represented by positional information (frame information (AFRAME), second information (ASEC), and minute information (AMIN)) obtained from the sub-code information detection circuit 69 and count values EFMC and CDC based on positional information obtained from the counter 72. The memory 74 changes its operation in accordance with the trace signal T1.

That is, in a case where the trace signal T1 is logical “0” (that is, in the first tracing), the memory 74 records the detection pulse NP output from the 9T-or-more-long pattern detection circuit 62 on the basis of the addressees represented by the positional information. Meanwhile, in a case where the trace signal T1 exhibits logical “1” (that is, in the second tracing), the stored contents are output as a timing signal EP on the basis of the addresses represented by the positional information.

A modulation circuit 75 (see FIG. 15) in this embodiment has a configuration similar to that of the modulation circuit 25 shown in FIG. 11. That is, the modulation circuit 75 includes a predetermined number of flip-flops that are connected in cascade. The flip-flops sequentially transfer the frame pulse FP in accordance with a channel clock period. Furthermore, in the modulation circuit 75, outputs from a specific number of flip-flops are received. Thus, the modulation circuit 75 generates a timing signal whose logical level rises during a one-channel-clock period T after a length of 4T has passed from an edge Eg at the beginning of a pit 5 having a length of 9T or more.

Furthermore, the modulation circuit 75 generates M-series random-number data MS on the basis of the timing signal EP, and modulates the disc identification code ED on the basis of the M-series random-number data MS. That is, a result of the modulation is gated on the basis of the timing signal generated by the flip-flops, and an output signal MX is output.

Thus, the finishing device 60 records the modulated identification code EDr for each of the pits 5 having a length of 9T or more that meets the conditions explained with reference to equation (3).

That is, even in a case where the reflectance of only a length of 1T is changed in a position that is separated by a length of 4T from an edge Eg at the beginning of a pit 5 having a length of 9T or more and that is displaced in the disc inner-outer circumferential direction, the reflectance can be changed without influencing positional information of the preceding and succeeding edges Eg. In addition, compared with a pit 5 and a space Sp each having a length of 11T corresponding to a frame sync, a pit 5 having a length of 9T or more occurs more frequently. Thus, the code mark MK representing one bit of the modulated identification code EDr can be recorded for many pits 5. Therefore, the reliability of the modulated identification code EDr can be improved.

Consequently, in a case where a CD according to this embodiment is played back, a pattern detection circuit having the same configuration as that of the 9T-or-more-long pattern detection circuit 62 included in the finishing device 60 detects pits each having a length of 9T or more. Then, for the detected pits 5, the signal level of the tracking error signal TE is detected, and the disc identification code ED is reproduced.

### (2-2) Operations and Advantages

With the configuration described above, the finishing device 60 detects pits 5 each having a length of 9T or more, and forms a code mark MK in a desired application position that is displaced in the disc inner-outer circumferential direction by a specific distance from the track center line C_{TR}. Accordingly, modulated identification code EDr representing sub-data is recorded.

Thus, compared with the finishing device 6 in the first embodiment, the finishing device 60 is capable of recording modulated identification code EDr for pits 5 each having a length in a range from 9T to 11T, which occur with high frequency. Thus, a large amount of modulated identification code EDr can be recorded as code marks MK on the optical disc 100C.

In addition, in the finishing device 60, by setting a desired application position that is separated by a specific separation distance from an edge Eg of a detected pit 5 having a length of 9T or more, it is not necessary to change a separation length from the edge Eg to the desired application position in accordance with the length of the pit 5. Thus, the configuration of the finishing device 60 can be simplified.

In addition, the finishing device 60 is capable of recording the modulated identification code EDr on the optical disc 100C in a short period of time by reducing the time allocated to one bit of disc identification code when necessary. In addition, the finishing device 60 is capable of improving the recording density.

Thus, since the modulated identification code EDr is recorded in limited areas of the optical disc 100C, the optical disc playback device 31 is capable of reading the modulated identification code EDr in a short period of time and quickly determining whether or not the optical disc 100C is an authorized optical disc.

With the configuration described above, the finishing device 60 forms code marks MK for pits 5 each having a length of 9T or more. Thus, the finishing device 60 is capable of recording the modulated identification code EDr at a recording density higher than that in the first embodiment, with only negligible influence being exerted on the reproduction signal RF.

### Third Embodiment

### (3-1) Configuration of Finishing Device

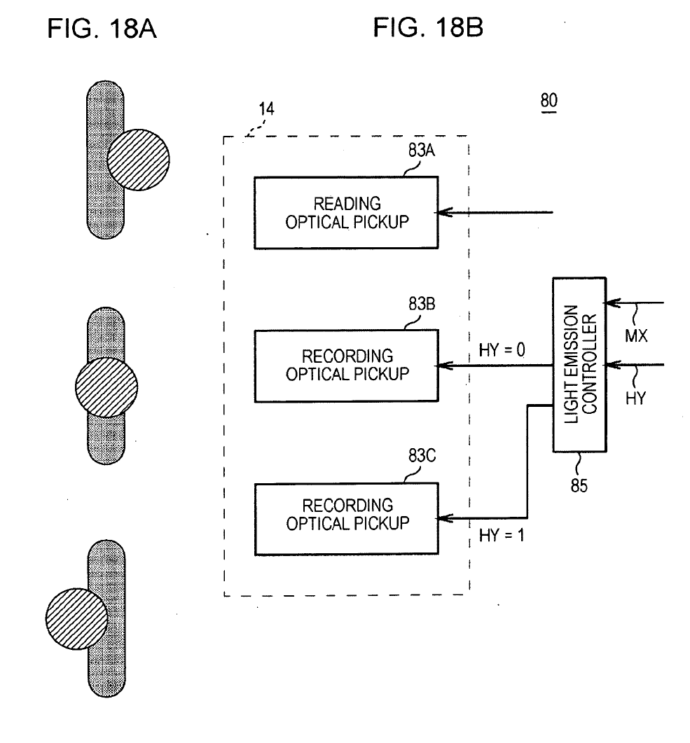

In a third embodiment described with reference to FIGS. 18 to 20, parts corresponding to those in the second embodiment described above with reference to FIGS. 15 to 17 are denoted by the same reference numerals and signs. A finishing device (code mark recording device) 80 according to the third embodiment is different from the finishing device 60 according to the second embodiment in that the finishing device 80 includes a reading optical pickup 83A configured to apply servo optical beams L to the track center line C_{TR} in advance and two recording optical pickups 83B and 83C that are positioned so as to apply recording optical beams to a desired application position. In addition, the finishing device 80 is different from the finishing device 60 in that the finishing device 80 performs detection of pits 5 each having a length of 9T or more and formation of code marks MK at the same time in parallel.

That is, the finishing device 80 includes the reading optical pickup 83A configured to read a reproduction signal RF in advance, and the recording optical pickups 83B and 83C configured to perform scanning of a scanning path that has been scanned by the reading optical pickup 83A with a delay of a specific time.

An objective lens 18X (not illustrated) included in the reading optical pickup 83A and objective lenses 18Y and 18Z (not illustrated) included in the recording optical pickups 83B and 83C are held in the same lens holder and driven at the same time. In addition, the objective lenses 18Y and 18Z for applying recording optical beams are located in positions displaced on opposite sides in the disc inner-outer circumferential direction with respect to the objective lens 18X for applying servo optical beams.

In addition, the objective lenses 18X, 18Y, and 18Z are positioned in such a manner that a recording optical beam is applied so as to be separated in the disc inner-outer circumferential direction by a specific distance from a servo optical beam and that the recording optical beam is applied to a position where the servo optical beam has been applied with a delay of a specific time.

As shown in FIG. 18, the finishing device 80 performs servo control so that optical beams L are applied to the track center line C_{TR} on the basis of the reading optical pickup 83A. In addition, in the finishing device 80, the reading optical pickup 83A receives reflected servo optical beams that are the servo optical beams reflected by the optical disc 100. Then, the finishing device 80 processes a reproduction signal RF obtained from the reflected servo optical beams, and detects pits 5 each having a length of 9T or more.

Then, on the basis of an output signal MX and a desired position control signal HY supplied from a recording controller 13Y, the finishing device 80 records modulated identification code EDr for each of the detected pits 5 having a length of 9T or more, by using the recording optical pickups 83B and 83C.

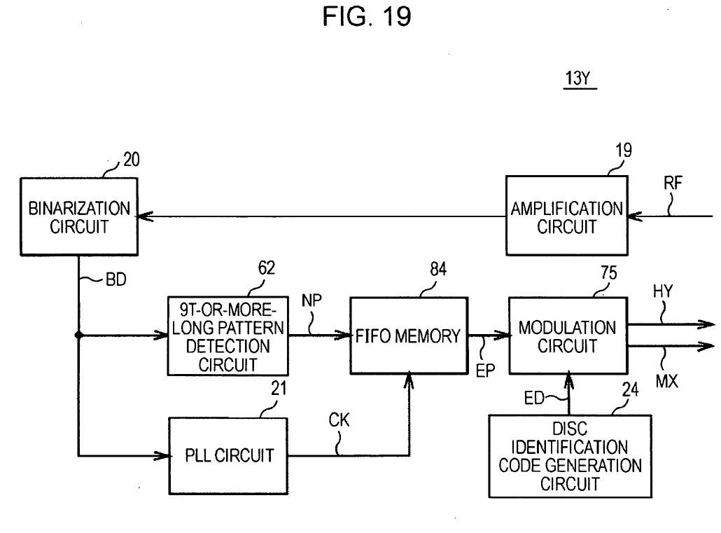

That is, as shown in FIG. 19, in the recording controller 13Y of the finishing device 80, a result NP of the detection from the 9T-or-more-long pattern detection circuit 62 is input to a first-in first-out (FIFO) memory 84. The detection result is delayed by a specific time and then supplied to a modulation circuit 75. Thus, a delay time for the recording optical pickups 33B and 83C to perform scanning of a scanning path that has been scanned by the reading optical pickup 83A can be compensated for.

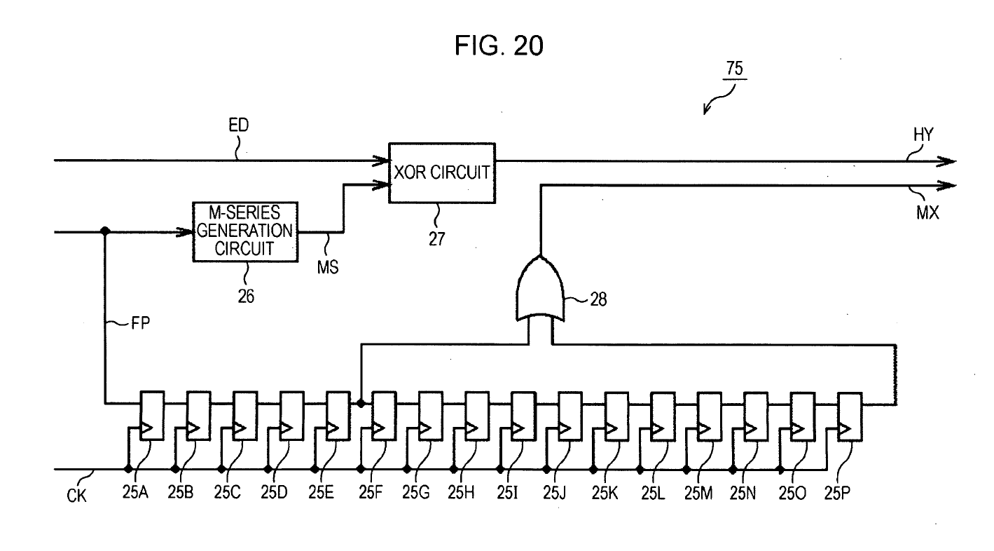

As shown in FIG. 20, the modulation circuit 75 corresponding to the modulation circuit 25 (see FIG. 11) supplies, to a light emission controller 85 provided in a stage previous to the recording optical pickups 83B and 83C, an exclusive logical OR signal WP output from the exclusive-OR circuit 27 as a desired position control signal HY. In addition, the modulation circuit 75 supplies the signal MX output from the OR circuit 28 to the light emission controller 85.

When receiving the desired position control signal HY which exhibits “0” and the output signal MX, the light emission controller 85 (see FIG. 18) controls the recording optical pickup 83B to, for example, apply optical beams to a desired application position that is displaced in a disc outer circumferential direction by a specific distance from the track center line C_{TR}, so that a code mark MK is formed.

In addition, when receiving the desired position control signal HY which exhibits “1” and the output signal MX, the light emission controller 85 controls the recording optical pickup 83C to, for example, apply optical beams to a desired application position that is displaced in a disc inner circumferential direction by the specific distance from the track center line C_{TR}, so that the code mark MK is formed.

### (3-2) Operations and Advantages

In the configuration described above, the finishing device 80 applies servo optical beams for servo control to the optical disc 100C by using the reading optical pickup 83A, and applies servo optical beams to the track center line C_{TR}, which is the center of the pits 5 and the spaces Sp, on the basis of reflected servo optical beams that are the servo optical beams reflected by the optical disc 100C.

In addition, by applying recording optical beams to a position that is displaced from servo optical beams by a specific distance by using the recording optical pickups 83B and 83C, the finishing device 80 applies recording optical beams to a desired application position.

Consequently, the finishing device 80 allows the reading optical pickup 83A to be concentrated on servo control and reading of a reproduction signal RF. Thus, the finishing device 80 is capable of forming a code mark MK in a more accurate position under stable servo control. In addition, since it is not necessary to displace servo optical beams from the track center line C_{TR}, the quality of a reproduced RF signal can be stabilized.

In addition, in the finishing device 80, application of servo optical beams by the reading optical pickup 83A is performed prior to application of recording optical beams by the recording optical pickups 33B and 83C.

Thus, since a pit having a length of 9T or more can be detected in a time between application of servo optical beams and application of recording optical beams, a code mark MK can be formed at the same time in parallel with a single reproducing operation of a main-data sequence. Thus, the time necessary for the processing can be shortened.

With the configuration described above, the finishing device 80 includes the reading optical pickup 83A and the recording optical pickups 83B and 83C. Thus, the finishing device 80 performs, by using the reading optical pickup 83A, servo control and reading of a main-data sequence, and performs, by using the recording optical pickups 83B and 83C, formation of a code mark MK. Thus, the finishing device 80 is capable of performing reading of the main-data sequence and formation of the code mark MK at different timings. Therefore, the code mark MK can be formed for each of the pits 5 having a length of 9T or more, as in the second embodiment, by reading the main-data sequence only once.

### Other Embodiments

Although a case where the film structure of a CD-R is applied to a reflective recording surface in the embodiments described above, the present invention is not limited to this case. For example, the film structure of a phase-change optical disc may be applied to the reflective recording surface.

In addition, in the first embodiment, a case where the reflectance of the information recording surface 3A in a position that is separated by a length of 5T or more from each edge Eg of the pits 5 and that is displaced in the disc inner-outer circumferential direction is locally changed has been described. In the second and third embodiments, a case where the reflectance of the information recording surface 3A in a position that is separated by a length of 4T or more from each edge Eg of the pits 5 and that is displaced in the disc inner-outer circumferential direction is locally changed has been described. However, the present invention is not limited to these cases. Even when the reflectance of the information recording surface 3A in a position that is separated by a length of 3T or more from each edge Eg of the pits 5 and that is displaced in the disc inner-outer circumferential direction is locally changed, a similar advantage can be achieved.

That is, in a case where the reflectance of the information recording surface 3A in a position that is in close proximity to an edge Eg of each of the pits 5 is locally changed, jitters occur in a reproduction signal RF. However, in a CD player actually used, even if some jitters occur in the reproduction signal RF from the pits 5, data represented by a pit sequence can be reproduced substantially without problems.

Regarding the relationship with such jitters, for example, in an EFM method used for modulation of CDs, the minimum inversion interval is set to three channel clock periods. The occurrence of jitters caused by a change in the reflectance or the like in a position that is separated from an edge Eg of each of the pits 5 by the minimum inversion interval is negligible. Thus, by additionally recording the disc identification code ED in a position that is separated from edges Eg of each of the pits 5 by the minimum inversion interval or more and that is displaced in the disc inner-outer circumferential direction, the occurrence of jitters caused by the disc identification code ED can be maintained sufficiently small, and data represented by a pit sequence can be reliably reproduced. Thus, for example, in the case of CDs, by locally changing the reflectance of a position that is separated by a distance corresponding to three channel clock periods from each edge Eg of a pit, modulated identification code EDr can be recorded without problems.

Note that in a case where the modulated identification code EDr is recorded in a position that is separated from each edge Eg of the pits 5 by a distance corresponding to three channel clock periods, the modulated identification code EDr can be recorded for the pits 5 each having a length of 7T or more and for the spaces Sp each having a length of 7T or more.

In addition, although a case where disc identification code is recorded for pits 5 each having a length of 9T or more has been described in the second and third embodiments, the present invention is not limited to this case. The disc identification code may be recorded for pits 5 each having a length of 9T or more and for spaces Sp each having a length of 9T or more.

Furthermore, although a case where modulated identification code EDr is recorded in a position that is separated by a length of 4T from an edge Eg at the beginning of each of the pits 5 having a length of 9T or more has been described in the second and third embodiments, the present invention is not limited to this case. The modulated identification code EDr may be recorded in a position that is in a central portion of each of the pits 5 having a length or 9T or more and that is displaced in the disc inner-outer circumferential direction.

In addition, although a case where disc identification code is recorded for a sync frame portion that can be predicted has been described in the first embodiment, the present invention is not limited to this case. Any signal can be used as long as the occurrence of the signal can be predicted in advance. For example, in a case where information on the whole or part of a signal recorded on a CD is available, a pit sequence on the optical disc 100 can be predicted. In such a case, by using this method, a position that is sufficiently separated from an edge Eg of a pit is detected, and a laser output to the predicted position is instantaneously increased. Accordingly, modulated identification code EDr can be additionally recorded.

Furthermore, although a case where the reflectance of an information recording surface is locally changed for a one-channel-clock period in each of pits 5 and spaces Sp having a specific length or more has been described in the foregoing embodiments, the present invention is not limited to this case. In short, by changing the reflectance of a position that is separated by a specific distance from the preceding and succeeding edges Eg, modulated identification code EDr can be recorded without losing information on an edge Eg. Thus, for example, in the case of the pits 5 and the spaces Sp each having a length of 9T, the reflectance of a central portion having a length of 3T can be changed.

In addition, although a case where a code mark MK is formed in a position that is displaced in the disc inner-outer circumferential direction from the track center line C_{TR} by a specific distance has been described in the foregoing embodiments, the present invention is not limited to this case. The code mark MK may be formed in a position that is displaced in the disc inner-outer circumferential direction from the track center line C_{TR} by a desired distance.

Furthermore, although a case where sub-data is recorded on a bit-by-bit basis as a code mark MK has been described in the foregoing embodiments, the present invention is not limited to this case. For example, by changing the length of the code mark MK, the sub-data can be recorded in units of a plurality of bits. In addition, data for a plurality of bits may be recorded by setting a plurality of distances between the code mark MK and the track center line C_{TR}.

Furthermore, although a case where the disc identification code ED is modulated and then recorded as modulated identification code EDr has been described in the foregoing embodiments, the present invention is not limited to this case. The disc identification code ED may be directly recorded. In addition, no restriction is imposed on the modulation method for the disc identification code ED. Various modulation methods can be employed.

Furthermore, although a case where disc identification code ED is recorded has been described in the foregoing embodiments, the present invention is not limited to this case. Main data may be encrypted and then recorded as pits 5 and spaces Sp, and key information necessary for decryption may be recorded as sub-data. Furthermore, various types of data necessary for decryption, such as, for example, data necessary for selection and decoding of key information, may be recorded as sub-data.

Furthermore, although a case where modulated identification code EDr is recorded on the optical disc 100C has been described in the foregoing embodiments, the present invention is not limited to this case. For example, a similar function may be provided in an optical disc playback device, so that the number of times data has been reproduced and the number of times data has been copied can be recorded as sub-data.

Furthermore, although a case where a sub-data sequence represented by disc identification code ED is reproduced by performing binary identification of the accumulated value by the accumulator 53 has been described in the foregoing embodiments, the present invention is not limited to this case. Multi-level identification of the accumulated value may be performed so that a sub-data sequence can be reproduced.

Furthermore, although a case where EFM modulation is performed so that a digital audio signal is recorded has been described in the foregoing embodiments, the present invention is not limited to this case. Various types of modulation, such as 1-7 modulation, 8-16 modulation, and 2-7 modulation, can be employed.

Furthermore, although a case where desired main data is recorded on the basis of the pits 5 and the spaces Sp has been described in the foregoing embodiments, the present invention is not limited to this case. The present invention is widely applicable to, for example, a case where desired main data is recorded on the basis of recording marks and spaces based on, for example, a phase-change method or an organic dye method.

Furthermore, although a case where the present invention is applied to a CD and a peripheral device and an audio signal is recorded has been described in the foregoing embodiments, the present invention is not limited to this case. The present invention is widely applicable to, for example, various optical discs such as DVDs or BDs, and various peripheral devices.

Furthermore, although a case where the two recording optical pickups 83B and 83C are provided has been described in the third embodiment, the present invention is not limited to this case. For example, by providing, in addition to the objective lens 18X of the reading optical pickup 83A, a driving unit configured to drive the objective lens, and by driving the objective lens using the driving unit, a configuration similar to that in the third embodiment can be realized by using one recording optical pickup. In addition, two objective lenses may be provided in a recording optical pickup and one of the objective lenses that is to collect light can be switched in accordance with a desired position control signal HY.

Furthermore, although a case where the finishing device (6, 60, 80) as an optical disc recording device is constituted by the recording controller (13, 13×, 13Y) and the optical pickup unit 14 serving as a recording unit has been described in the foregoing embodiments, the present invention is not limited to this case. An optical disc recording device according to an embodiment of the present invention may be constituted by a recording unit having various other configurations.

Furthermore, although a case where the optical disc playback device 31 as an optical disc playback device is constituted by the laser diode 16 serving as a light source, the objective lens 18 serving as an objective lens, the photo detector 17 serving as a light-receiving unit, the binarization circuit 35, the E-M demodulation circuit 37, and the ECC circuit 38 serving as a main reproducing unit, the disc identification code reproducing circuit 41 serving as a sub-reproducing unit, and the system control circuit 40 serving as a reproduction stopping unit has been described in the foregoing embodiments, the present invention is not limited to this case. An optical disc playback device according to an embodiment of the present invention may be constituted by reproducing units having various other configurations.

It should be understood by those skilled in the art that various modifications, combinations, sub-combinations and alterations may occur depending on design requirements and other factors insofar as they are within the scope of the appended claims or the equivalents thereof.

What is claimed is:

1. An optical disc recording device comprising:
a recording unit configured to apply optical beams, on an optical disc on which a main-data sequence is recorded in advance by forming recording marks and spaces having lengths corresponding to the main-data sequence on a track center line on an information recording surface of the optical disc, to a desired application position that is displaced in a disc inner-outer circumferential direction by a specific distance from the track center line in a recording mark having a specific length or more or a space having the specific length or more, or in the recording mark and the space each having the specific length or more, and thus locally change a reflectance of the information recording surface, so that a sub-data sequence is recorded on the optical disc.

2. The optical disc recording device according to claim 1, wherein the recording unit includes
a light source configured to emit the optical beams,
an objective lens configured to collect the optical beams and apply the collected optical beams to the optical disc,
an objective lens driving unit configured to drive the objective lens, and
a recording controller configured to control the objective lens driving unit to apply the optical beams to the desired application position and control the light source in such a manner that an emission light intensity of the optical beams applied to the desired application position is significantly increased, on the basis of reflected optical beams that are the optical beams reflected by the optical disc.

3. The optical disc recording device according to claim 2, wherein the recording controller records the sub-data sequence on a bit-by-bit basis in a plurality of recording marks or a plurality of spaces, or in the plurality of recording marks and the plurality of spaces.

4. The optical disc recording device according to claim 3, wherein the recording controller records the sub-data sequence on the optical disc by locally changing the reflectance of the information recording surface in accordance with a data sequence obtained by modulating the sub-data sequence by using a pseudo-random number series.

5. The optical disc recording device according to claim 4, wherein the following expression is met:
D≦p/4
where p represents a distance between recording marks or between adjacent tracks in which the recording marks are recorded and D represents the specific distance.

6. The optical disc recording device according to claim 4, wherein the sub-data sequence includes an identification data sequence for identifying the optical disc.

7. The optical disc recording device according to claim 1,
wherein the main-data sequence includes an encrypted data sequence, and
wherein the sub-data sequence includes a data sequence necessary for decrypting the encrypted main-data sequence.

8. The optical disc recording device according to claim 1, wherein the sub-data sequence includes data indicating the number of times the main-data sequence has been reproduced.

9. The optical disc recording device according to claim 1, wherein the sub-data sequence includes data indicating the number of times the main-data sequence has been copied.

10. The optical disc recording device according to claim 2, wherein, on the basis of the reflected optical beams, the recording controller predicts a timing at which the recording mark having the specific length or more or the space having the specific length or more, or the recording mark and the space each having the specific length or more are scanned with the optical beams, and determines the desired application position on the basis of a result of the prediction.

11. The optical disc recording device according to claim 2,
wherein, on the basis of the reflected optical beams, the recording controller predicts a timing at which the recording mark having the specific length or more or the space having the specific length or more, or the recording mark and the space each having the specific length or more are scanned with the optical beams, and temporarily stores a result of the prediction, and
wherein the recording controller determines the desired application position on the basis of the sub-data sequence and the result of the prediction.

12. The optical disc recording device according to claim 1, further comprising:
a servo optical system configured to apply servo optical beams for servo control to the optical disc and to apply, on the basis of reflected servo optical beams that are the servo optical beams reflected by the optical disc, the servo optical beams to each of a midpoint between two edges of the recording mark and a midpoint between two edges of the space, wherein
the recording unit applies the optical beams to the desired application position by applying the optical beams to a position that is displaced from the servo optical beams by the specific distance.

13. The optical disc recording device according to claim 12, wherein the recording controller determines the desired application position on the basis of the reflected servo optical beams.

14. A recording method comprising the steps of:
applying optical beams, on an optical disc on which a main-data sequence is recorded in advance by forming recording marks and spaces having lengths corresponding to the main-data sequence on a track center line on an information recording surface of the optical disc, to a desired application position that is displaced in a disc inner-outer circumferential direction by a specific distance from the track center line in a recording mark having a specific length or more or a space having the specific length or more, or in the recording mark and the space each having the specific length or more, and thus locally changing a reflectance of the information recording surface, so that a sub-data sequence is recorded on the optical disc.

15. An optical disc, wherein a main-data sequence is recorded by forming recording marks and spaces having lengths corresponding to the main-data sequence on a track center line on an information recording surface of the optical disc and a sub-data sequence is recorded by locally changing a reflectance of the information recording surface in a desired application position that is displaced in a disc inner-outer circumferential direction by a specific distance from the track center line in a recording mark having a specific length or more or a space having the specific length or more, or in the recording mark and the space each having the specific length or more.

16. An optical disc playback device comprising:
a light source configured to emit optical beams;
an objective lens configured to collect the optical beams and apply the collected optical beams to an optical disc on which a main-data sequence is recorded by forming recording marks and spaces having lengths corresponding to the main-data sequence on a track center line on an information recording surface of the optical disc and a sub-data sequence is recorded by locally changing a reflectance of the information recording surface in a desired application position that is displaced in a disc inner-outer circumferential direction by a specific distance from the track center line in a recording mark having a specific length or more or a space having the specific length or more, or in the recording mark and the space each having the specific length or more;
a light-receiving unit configured to receive, in two detection areas equally divided in the disc inner-outer circumferential direction, reflected optical beams that are the optical beams reflected by the optical disc;
a main reproducing unit configured to reproduce the main-data sequence on the basis of the total amount of the reflected optical beams;
a sub-reproducing unit configured to reproduce the sub-data sequence on the basis of a change in the difference between the amounts of the reflected optical beams in the two detection areas; and
a reproduction stopping unit configured to stop reproduction of the main-data sequence in a case where the sub-data sequence is not correctly reproduced.
